(19) United States
(12) Patent Application Publication
(10) Pub. No.: US 2020/0200957 A1
(43) Pub. Date: Jun. 25, 2020

(54) POLARIZATION SEPARATION ELEMENT, METHOD OF DESIGNING POLARIZATION SEPARATION ELEMENT, OPTICAL SYSTEM, AND OPTICAL INSTRUMENT

(71) Applicant: OLYMPUS CORPORATION, Tokyo (JP)

(72) Inventors: Nobuyoshi TOYOHARA, Sagamihara-shi (JP); Koichi OGAWA, Hiratsuka-shi (JP)

(73) Assignee: OLYMPUS CORPORATION, Tokyo (JP)

(21) Appl. No.: 16/810,380

(22) Filed: Mar. 5, 2020

Related U.S. Application Data
(63) Continuation of application No. PCT/JP2018/037919, filed on Oct. 11, 2018.

(30) Foreign Application Priority Data
Nov. 29, 2017 (JP) 2017-229612

(51) Int. Cl. G02B 5/30

(52) U.S. Cl. CPC G02B 5/3008

(57) ABSTRACT

A polarization separation element that deals with a wide range of angles of incidence by a simple multilayer film (stacked-layer film), without having a need of a structural birefringent layer, a method of designing a polarization separation element, an optical system, and an optical instrument are provided.

The polarization separation element is formed between a pair of light transmissive substrates and having a transmittance of P-polarized light and a transmittance of S-polarized light differing by at least B % or more in an entire section of wavelength from wavelength A1 (nm) to A2 (nm),
and where, at a design wavelength λ (nm), A1=λ×0.86, A2=λ×1.7, and B (%)=22.5,

The polarization separation element has a structure of alternately stacked dielectrics, including at least a broadband polarization separation film configuration, a first narrowband polarization separation film configuration, and a second narrowband polarization separation film configuration.

### CROSS-REFERENCE TO RELATED APPLICATION

The present application is a continuation application of PCT/JP2018/037919 filed on Oct. 11, 2018 which is based upon and claims the benefit of priority from Japanese Patent Application No. 2017-229612 filed on Nov. 29, 2017; the entire contents of which are incorporated herein by reference.

### BACKGROUND OF THE INVENTION

### Field of the Invention

The disclosure relates to a polarization separation element, a method of designing a polarization separation element, an optical system, and an optical instrument.

### Description of the Related Art

A polarization separation element in which, a dielectric multilayer film is used, has been known heretofore. Moreover, an arrangement that can cope with a wide range of angles of incidence, and in which the dielectric multilayer film is used, has been proposed in Japanese Patent Application Laid-open Publication No. 2010-152391.

### SUMMARY

A polarization separation element according to at least some embodiments of the present disclosure is a polarization separation element formed between a pair of light transmissive substrates and having a transmittance of P-polarized light and a transmittance of S-polarized light differing by at least B % or more than B % or more in an entire section of wavelength from wavelength A1 (nm) to wavelength A2 (nm),

and where,

at a design wavelength λ (nm)

A1=λ×0.86,

A2=λ×1.7, and

B=22.5, wherein

the polarization separation element has a structure of alternately stacked dielectrics in which, a first dielectric having a first refractive index and a second dielectric having a second refractive index lower than the first refractive index are stacked alternately, and

the structure of alternately stacked dielectrics includes a broadband polarization separation film configuration having spectral characteristics such that, each of a transmittance height difference of the P-polarized light and a transmittance height difference of the S-polarized light is at most within 15%, in a section of wavelength range which is at least ¼ of the entire section of wavelength from the wavelength A1 (nm) to the wavelength A2 (nm), and

the structure of alternately stacked dielectrics, in a first wavelength range narrower than a wavelength range included in the entire section of wavelength, has a first narrowband polarization separation film configuration having spectral characteristics such that the transmittance of the P-polarized light and the transmittance of the S-polarized light differ by at least 30% or more, in a wavelength section range which is at least ⅛ of the entire section of wavelength from the wavelength A1 (nm) to the wavelength A2 (nm), and

the structure of alternately stacked dielectrics, in a second wavelength range not overlapping with the first wavelength range, which is narrower than the wavelength range included in the entire wavelength, has a second narrowband polarization separation film configuration having spectral characteristics such that, the transmittance of the P-polarized light and the transmittance of the S-polarized light differ by at least 30% or more in a wavelength section range which is at least ⅛ of the entire section of wavelength from the wavelength A1 (nm) to the wavelength A2 (nm).

Moreover, a method of designing a polarization separation element according to at least some embodiments of the present disclosure is a method of designing a polarization separation element separating P-polarized light and S-polarized light in a predetermined wavelength range, formed between a pair of light transmissive substrates, includes at least steps of:

designing a broadband polarization separation film configuration having spectral characteristics such that, a transmittance of P-polarized light and a transmittance of S-polarized light in a first wavelength range included in a predetermined wavelength range differ by a predetermined value or a value higher than a predetermined value,

designing a first narrowband polarization separation film configuration having spectral characteristics such that, a transmittance of P-polarized light and a transmittance of S-polarized light in a second wavelength range narrower than the first wavelength range and included in the first wavelength range, differ by a predetermined value or a value higher than the predetermined value, and

designing a second narrowband polarization separation film configuration having spectral characteristics such that, in a third wavelength range narrower than the first wavelength range and not overlapping with the second wavelength range, and included in the first wavelength range, a transmittance of P-polarized light and a transmittance of S-polarized light differ by a predetermined value or a value higher than the predetermined value.

Moreover, an optical system according to at least some embodiments of the present disclosure includes the above mentioned polarization separation element.

Furthermore, an optical instrument according to at least some embodiments includes the above mentioned optical system.

### BRIEF DESCRIPTION OF THE DRAWINGS

FIG. 1 is a diagram showing a layer configuration of a polarization separation element according to an example 1;

FIG. 2 is a diagram showing transmittance characteristics of the polarization separation element according to the example 1;

FIG. 3 is another diagram showing transmittance characteristics of the polarization separation element according to the example 1;

FIG. 4 is still another diagram showing transmittance characteristics of the polarization separation element according to the example 1;

FIG. 5 is another diagram showing transmittance characteristics of the polarization separation element according to the example 1;

FIG. 6 is still another diagram showing transmittance characteristics of the polarization separation element according to the example 1;

FIG. 7 is a diagram showing a layer configuration of a polarization separation element according to an example 2;

FIG. 8 is a diagram showing transmittance characteristics of the polarization separation element according to the example 2;

FIG. 9 is another diagram showing transmittance characteristics of the polarization separation element according to the example 2;

FIG. 10 is still another diagram showing transmittance characteristics of the polarization separation element according to the example 2;

FIG. 11 is another diagram showing transmittance characteristics of the polarization separation element according to the example 2;

FIG. 12 is still another diagram showing transmittance characteristics of the polarization separation element according to the example 2;

FIG. 13 is a diagram showing a layer configuration of a polarization separation element according to an example 3;

FIG. 14 is a diagram showing transmittance characteristics of the polarization separation element according to the example 3;

FIG. 15 is another diagram showing transmittance characteristics of the polarization separation element according to the example 3;

FIG. 16 is still another diagram showing transmittance characteristics of the polarization separation element according to the example 3;

FIG. 17 is another diagram showing transmittance characteristics of the polarization separation element according to the example 3;

FIG. 18 is still another diagram showing transmittance characteristics of the polarization separation element according to the example 3;

FIG. 19 is a diagram showing a layer configuration of a polarization separation element according to an example 4;

FIG. 20 is a diagram showing transmittance characteristics of the polarization separation element according to the example 4;

FIG. 21 is another diagram showing transmittance characteristics of the polarization separation element according to the example 4;

FIG. 22 is still another diagram showing transmittance characteristics of the polarization separation element according to the example 4;

FIG. 23 is another diagram showing transmittance characteristics of the polarization separation element according to the example 4;

FIG. 24 is still another diagram showing transmittance characteristics of the polarization separation element according to the example 4;

FIG. 25 is a diagram showing a layer configuration of a polarization separation element according to an example 5;

FIG. 26 is a diagram showing transmittance characteristics of the polarization separation element according to the example 5;

FIG. 27 is another diagram showing transmittance characteristics of the polarization separation element according to the example 5;

FIG. 28 is still another diagram showing transmittance characteristics of the polarization separation element according to the example 5;

FIG. 29 is another diagram showing transmittance characteristics of the polarization separation element according to the example 5;

FIG. 30 is still another diagram showing transmittance characteristics of the polarization separation element according to the example 5;

FIG. 31 is a diagram showing a layer configuration of a polarization separation element according to an example 6;

FIG. 32 is a diagram showing transmittance characteristics of the polarization separation element according to the example 6;

FIG. 33 is another diagram showing transmittance characteristics of the polarization separation element according to the example 6;

FIG. 34 is still another diagram showing transmittance characteristics of the polarization separation element according to the example 6;

FIG. 35 is another diagram showing transmittance characteristics of the polarization separation element according to the example 6;

FIG. 36 is still another diagram showing transmittance characteristics of the polarization separation element according to the example 6;

FIG. 37 is a diagram showing a layer configuration of a polarization separation element according to an example 7;

FIG. 38 is a diagram showing transmittance characteristics of the polarization separation element according to the example 7;

FIG. 39 is another diagram showing transmittance characteristics of the polarization separation element according to the example 7;

FIG. 40 is still another diagram showing transmittance characteristics of the polarization separation element according to the example 7;

FIG. 41 is another diagram showing transmittance characteristics of the polarization separation element according to the example 7;

FIG. 42 is still another diagram showing transmittance characteristics of the polarization separation element according to the example 7;

FIG. 43 is still another diagram showing transmittance characteristics of the polarization separation element according to the example 7;

FIG. 44 is a diagram showing a layer configuration of a polarization separation element according to an example 8;

FIG. 45 is a diagram showing transmittance characteristics of the polarization separation element according to the example 8;

FIG. 46 is another diagram showing transmittance characteristics of the polarization separation element according to the example 8;

FIG. 47 is still another diagram showing transmittance characteristics of the polarization separation element according to the example 8;

FIG. 48 is another diagram showing transmittance characteristics of the polarization separation element according to the example 8;

FIG. 49 is still another diagram showing transmittance characteristics of the polarization separation element according to the example 8;

FIG. 50 is still another diagram showing transmittance characteristics of the polarization separation element according to the example 8;

FIG. 51 is a diagram showing an average refractive index of four layers on a transmissive substrate side of each example;

FIG. 52 is a diagram showing an arrangement of a prim element having the polarization separation element according to each example;

FIG. 53 is a diagram showing an arrangement of an optical system according to an example 9;

FIG. 54 is a diagram showing a configuration of an optical instrument according to an example 10; and

FIG. 55 is another diagram showing an arrangement of the optical instrument according to the example 10.

### DETAILED DESCRIPTION

A polarization separation element, a method of designing a polarization separation element, an optical system, and an optical instrument according to an embodiment will be described below in detail by referring to the accompanying diagrams. However, the present disclosure is not restricted to the embodiment described below.

The polarization separation element according to the embodiment will be described below. The polarization separation element has a structure of alternately stacked dielectrics in which, a first dielectric having a first refractive index and a second dielectric having a second refractive index lower than the first refractive index are stacked alternately between a pair of light transmissive substrates.

Moreover, the polarization separation element is formed between the pair of light transmissive substrates, and a transmittance of P-polarized light and a transmittance of S-polarized light differ by at least B % or more in an entire section of wavelength from wavelength A1 (nm) to wavelength A2 (nm).

Where,

at a design wavelength λ (nm)

A1=λ×0.86,

A2=λ×1.7, and

B (%)=22.5.

The structure of alternately stacked dielectrics includes a broadband polarization separation film configuration having spectral characteristics such that, each of a transmittance height difference of the P-polarized light and a transmittance height difference of the S-polarized light is at most within 15%, in a section of wavelength range which is at least ¼ of the entire section of wavelength from the wavelength A1 (nm) to the wavelength A2 (nm).

Furthermore, the structure of alternately stacked dielectrics, in a first wavelength range narrower than a second wavelength range included in the entire section of wavelength, has a first narrowband polarization separation film configuration having spectral characteristics such that, the transmittance of the P-polarized light and the transmittance of the S-polarized light differ by at least 30% or more, in a wavelength section range which is at least ⅛ of the entire section of wavelength from the wavelength A1 (nm) to the wavelength A2 (nm).

Furthermore, the structure of alternately stacked dielectrics, in a second wavelength range not overlapping with the first wavelength range, which is narrower than the wavelength included in the entire section of wavelength, has a second narrowband polarization separation film configuration having spectral characteristics such that, the transmittance of the P-polarized light and the transmittance of the S-polarized light differ by at least 30% or more in a wavelength section range which is at least ⅛ of the entire section of wavelength from the wavelength A1 (nm) to the wavelength A2 (nm).

According to the above mentioned film configuration, it is possible to achieve a polarization separation element with a small ripple, that deals with a wide range of angles of incidence by a simple multilayer film (stacked-layer film), without having a need of a structural birefringent layer.

In expression (1) and all the description below, reference numeral ‘H’ denotes a film thickness of the first dielectric (high refractive index material layer) and ‘L’ denotes a film thickness of the second dielectric (low refractive index material layer).

In the polarization separation element, it is desirable that the broadband polarization separation film configuration has both or one of a first broadband polarization separation film configuration and a second broadband polarization separation film configuration, and includes in order from a light transmissive substrate, a first dielectric, a second dielectric, the first dielectric, and the second dielectric, and the film thickness H of the first dielectric and the film thickness L of the second dielectric satisfy the following expression (1).

H(0.24±a1)×d

L(0.8±a2)×e

H(0.45±a3)×f

L(3.3±a4)×g (1)

where,

a coefficient a1=0.15,

a coefficient a2=0.2,

a coefficient a3=0.2,

a coefficient a4=0.6,

a coefficient d is set such that, the first broadband polarization separation film configuration, d=1 and the second broadband polarization separation film configuration, d=1.2 to 1.5,

a coefficient e is set such that, the first broadband polarization separation film configuration, e=1 and the second broadband polarization separation film configuration, e=0.9 to 1.2,

a coefficient f is set such that, the first broadband polarization separation film configuration, f=1 and the second broadband polarization separation film configuration, f=0.4 to 0.8,

a coefficient g is set such that, the first broadband polarization separation film configuration, g=1 and the second broadband polarization separation film configuration, g=0.6 to 0.95.

Moreover, in the broadband polarization separation film configuration after the second broadband polarization separation film configuration, a relationship d=e=f=g is not established.

An optical film thickness is expressed as λ/4=1.0 (QWOT) when a reference wavelength is λ.

Moreover, according to a preferable aspect of the present embodiment,

each of the first narrowband polarization separation film configuration and the second narrowband polarization separation film configuration, has the first dielectric, the second dielectric, the first dielectric, the second dielectric, and the first dielectric stacked in order from the light transmissive substrate side, or, has the second dielectric, the first dielectric, the second dielectric, the first dielectric, and the second dielectric stacked in order from the light transmissive substrate side.

It is desirable that a film thickness H of the first dielectric and a film thickness L of the second dielectric satisfy one of the following expressions (2-1) and (2-2).

H(1.975±b1)×h,

L(1.975±b2)×i,

H(1.825±b3)×j,

L(1.675±b4)×k,

H(1.675±b5)×1 (2-1),

where,

a coefficient b1=0.4,

a coefficient b2=0.4,

a coefficient b3=0.3,

a coefficient b4=0.3, and

a coefficient b5=0.3,

and

L(1.975±b1)×h,

H(1.975±b2)×i,

L(1.825±b3)×j,

H(1.675±b4)×k, and

L(1.675±b5)×1 (2-2),

where,

the coefficient b1=0.4,

the coefficient b2=0.4,

the coefficient b3=0.3,

the coefficient b4=0.3, and

the coefficient b5=0.3.

a coefficient h is set such that the first narrowband polarization separation film configuration, h=1 and the second narrowband polarization separation film configuration, h=0.37±0.05,

a coefficient i is set such that the first narrowband polarization separation film configuration, i=1 and the second narrowband polarization separation film configuration, i=0.46±0.11,

a coefficient j is set such that the first narrowband polarization separation film configuration, j=1 and the second narrowband polarization separation film configuration, j=0.46±0.2,

a coefficient k is set such that the first narrowband polarization separation film configuration, k=1 and the second narrowband polarization separation film configuration, k=0.42±0.16, and

a coefficient l is set such that the first narrowband polarization separation film configuration, l=1 and the second narrowband polarization separation film configuration, l=0.28±0.1.

As mentioned above, the calculated value is the optical film thickness (QWOT). In the narrowband polarization separation film configuration after the second broadband polarization separation film configuration, a relationship h=i=j=k=l is not established.

Moreover, according to a preferable aspect of the present embodiment, it is desirable that the structure of alternately stacked dielectric includes a third narrowband polarization separation film configuration differing from the first narrowband polarization separation film configuration and the second narrowband polarization separation film configuration.

Moreover, according to a preferable aspect of the present embodiment, it is desirable that an average refractive index of each four layers from the light transmissive substrate side, in a polarization separation film configuration in contact with the pair of light transmissive substrates disposed at both ends of the structure of alternately stacked dielectrics is within a range of ±0.2 with respect to a refractive index of the light transmissive substrate.

Moreover, according to a preferable aspect of the present embodiment, it is desirable that the broadband polarization separation film configuration has spectral characteristics such that, at the maximum value of a range of an angle of incidence used, has a wavelength range for which, a difference in a transmittance Tp of the P-polarized light and a transmittance Ts of the S-polarized light is 10% or more, in a section of wavelength range which is at least ½ of the entire section of wavelength from the wavelength A1 (nm) to the wavelength A2 (nm), and

the broadband polarization separation film configuration, in the range of the angle of incidence used, has spectral characteristics such that, a transmittance height difference TTp of P-polarized light and a transmittance height difference TTs of S-polarized light is within 15% in a section of wavelength range which is at least ¼ of the entire section of wavelength from the wavelength A1 (nm) to the wavelength A2 (nm), and

at least one of the narrowband polarization separation film configurations, in the range of the angle of incidence used, the transmittance Tp of the P-polarized light and the transmittance Ts of the S-polarized light satisfy the following relationship.

transmittance Tp of P-polarized light>transmittance Ts of S-polarized light

Moreover, it is desirable that as a wavelength range that indicates spectral characteristics such that, the difference in the transmittance of the P-polarized light and the transmittance of the S-polarized light is 30% or more, has in a section of wavelength range which is at least ⅛ of the entire section of wavelength range from the wavelength A1 (nm) to the wavelength A2 (nm).

Moreover, according to a preferable aspect of the present embodiment, it is desirable that a layer in contact with the light transmissive substrate, a layer between the broadband polarization separation film configuration and one of the narrowband polarization separation film configurations, and at least a layer between the first narrowband polarization separation film configuration and the second narrowband polarization separation film configuration are matched.

Here, at the time of matching, it is possible to use a film thickness of another value differing from a value according to the above mentioned proportion and calculation method.

Moreover, according to a preferable aspect of the present embodiment, it is desirable to select the light transmissive substrate from optical glasses such as an alkali-free glass, a borosilicate glass, a fused quartz, a quartz crystal, BK7 (commercial product name), and Tempax (commercial product name) and the like, a crystalline material, a semiconductor substrate, and a synthetic resin.

Moreover, according to a preferable aspect of the present embodiment, it is preferable to select a material of the first dielectric (high refractive index material) and a material of the second dielectric (low refractive index material) from at least two types or more than two types from TiO, TiO₂, Y₂O₃, Ta₂O₅, ZrO, ZrO₂, Si, SiO₂, HfO₂, Ge, Nb₂O₅, Nb₂O₆, CeO₂, Cef₃, ZnS, ZnO, Fe₂O₃, MgF₂, AlF₃, CaF₂, LiF, Na₃AlF₆, Na₅AL₃F₁₄, Al₂O₃, MgO, LaF, PbF₂, NdF₃, or a mixture thereof.

Moreover, according to a preferable aspect of the present embodiment, it is desirable to adopt for a method of stacking two or more than two types of dielectrics of a material of the first dielectric (high refractive index material) and a material of the second dielectric (low refractive index material), any one of, vacuum deposition and sputtering, physical film-thickness vapor deposition of ion plating, resistance heating vapor deposition, electron beam heating vapor deposition, high frequency heating vapor deposition, laser beam heating vapor deposition, ionization sputtering, ion beam sputtering, plasma sputtering, ion assist, and radical-assisted sputtering.

Moreover, according to a preferable aspect of the present embodiment, it is desirable that the polarization separation element has the structure of alternately stacked dielectrics (polarization separation film configuration) in which, two or more than two types of dielectrics including a high refractive index material and a low refractive index material are stacked between a pair of light transmissive substrates, and the polarization separation element shows polarization separation characteristics at the maximum angle of incidence of 35 to 60 degrees.

Moreover, according to a preferable aspect of the present embodiment, it is desirable that the polarization separation element has the structure of alternately stacked dielectrics (polarization separation film configuration) in which, two or more than two types of dielectrics including a material of the first dielectric and a material of the second dielectric are stacked between a pair of the light transmissive substrates, and the polarization separation element has an adhesive layer including an adhesive, between a surface of any one of the pair of light transmissive substrates and the structure of the alternately stacked dielectrics.

A method of designing polarization separation element according to the present embodiment, which is a method of designing a polarization separation element separating P-polarized light and S-polarized light in a predetermined wavelength range, formed between a pair of light transmissive substrates, includes at least steps of:

designing a broadband polarization separation film configuration having spectral characteristics such that, a transmittance of P-polarized light and a transmittance of S-polarized light in a first wavelength range included in a predetermined wavelength range differ by a predetermined value or a value higher than a predetermined value,

designing a first narrowband polarization separation film configuration having spectral characteristics such that, a transmittance of P-polarized light and a transmittance of S-polarized light in a second wavelength range narrower than the first wavelength range and included in the first wavelength range, differ by a predetermined value or a value higher than the predetermined value, and

designing a second narrowband polarization separation film configuration having spectral characteristics such that, in a third wavelength range narrower than the first wavelength range and not overlapping with the second wavelength range, and included in the first wavelength range, a transmittance of P-polarized light and a transmittance of S-polarized light differ by a predetermined value or a value higher than the predetermined value.

Moreover, an optical system according to the present embodiment includes the above mentioned polarization separation element.

Moreover, an optical instrument according to the present embodiment includes the above mentioned optical system.

It is preferable to use the polarization separation element according to the present embodiment in an objective optical system for endoscope. However, without restricting to this, it possible to apply the polarization optical element according to the present embodiment to an objective lens for microscope, and a lens, a prism, and a filter of a camera, a pair of eyeglasses, a telescope and the like. The optical instrument according to the present embodiment, for instance, is these optical instruments, and the optical system according to the present embodiment, for instance, is an optical system in these optical instruments.

Here, each expression mentioned above need not be satisfied strictly, and it is needless to mention that, in view of the manufacturing error and performance that is required for the polarization separation element, the inventor of the present invention is capable of setting a tolerance appropriately. For instance, according to trial calculation of the inventor, it is practicable even with an error of 5%, and with an error of 3%, favorable characteristics were achieved. However, in a case in which, an accuracy in particular, is sought, the error of within 1% is preferable.

### Example 1

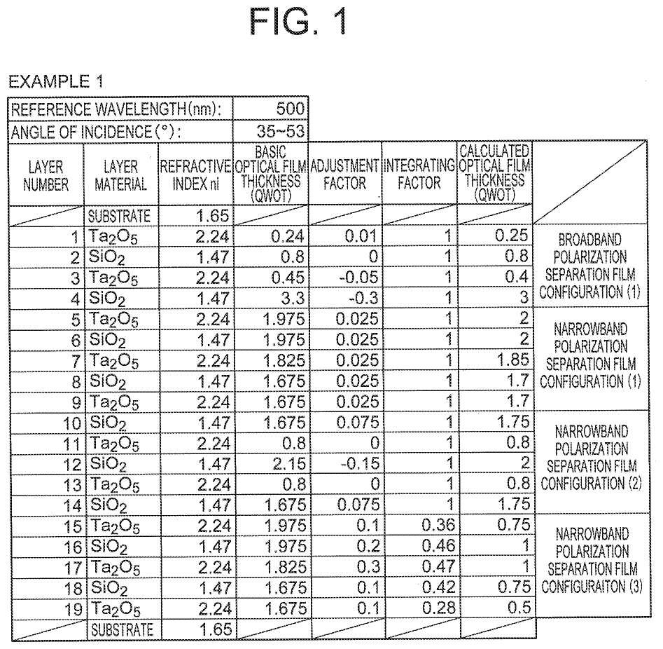

FIG. 1 is a diagram showing a layer configuration of a polarization separation element according to an example 1. An optical film thickness is expressed as λ/4=1.0 (QWOT) when a reference wavelength is λ. The polarization separation element of the present example is a polarization separation film configuration having 19 layers stacked alternately. As shown in FIG. 1, the polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, and a nineteenth layer from a light transmissive substrate side at an upper side shown in FIG. 1. SiO₂ as a low refractive index material, is disposed in order of a second layer, a fourth layer, a sixth layer, an eighth layer, a tenth layer, a twelfth layer, a fourteenth layer, a sixteenth layer, and an eighteenth layer.

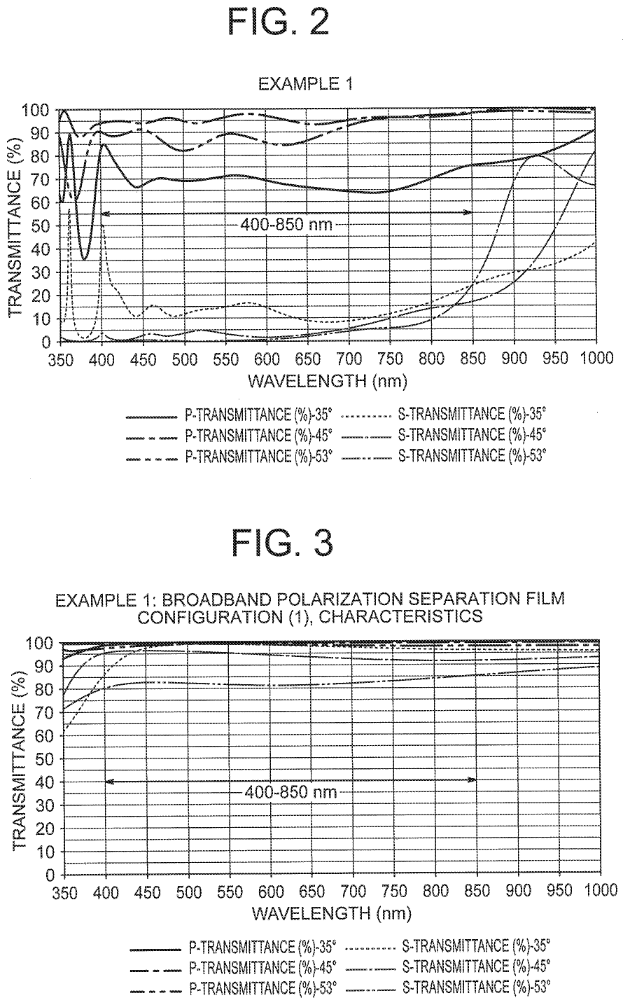

FIG. 2 is a diagram showing transmittance characteristics of the polarization separation element according to the example 1.

FIG. 3 is a diagram showing transmittance characteristics of a broadband polarization separation configuration (1) of the polarization separation element according to the example 1.

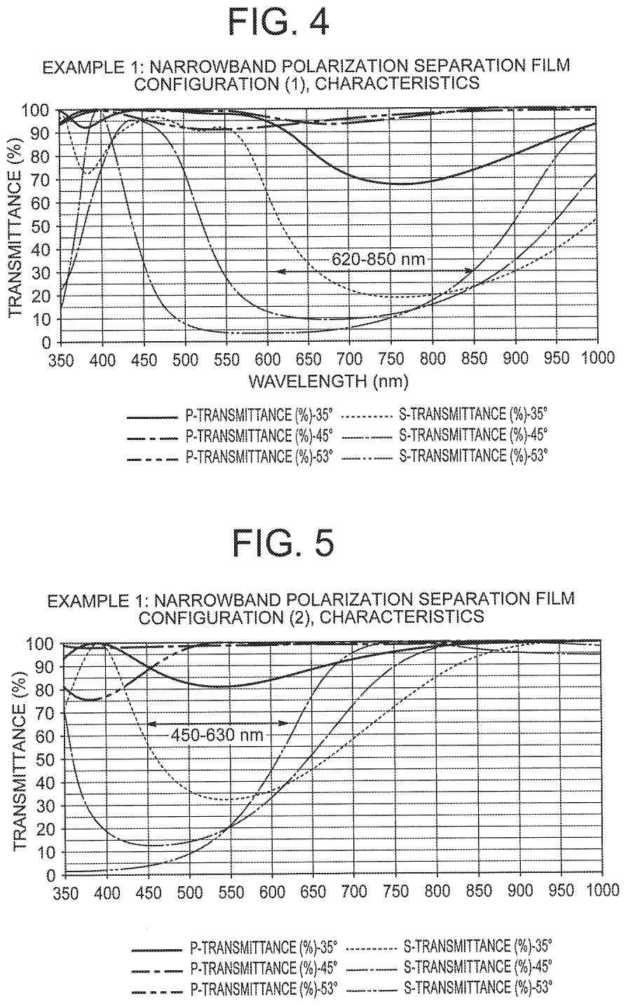

FIG. 4 is a diagram showing transmittance characteristics of a narrowband polarization separation configuration (1) of the polarization separation element according to the example 1.

FIG. 5 is a diagram showing transmittance characteristics of a narrowband polarization separation configuration (2) of the polarization separation element according to the example 1.

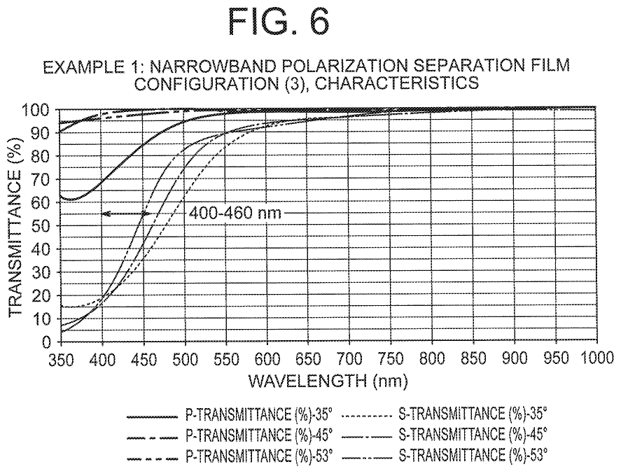

FIG. 6 is a diagram showing transmittance characteristics of a narrowband polarization separation configuration (3) of the polarization separation element according to the example 1. In all the diagrams of transmission characteristics below, wavelength (nm) is indicated on a horizontal axis and transmittance (%) is indicated on a vertical axis.

In the example 1, in each configuration of the broadband polarization separation configuration,

in ½ of the wavelength range of wavelength 400 nm to 850 nm, or in other words, at a wavelength 225 nm or more, the broadband polarization separation configuration has achieved a difference of 10% or more in a transmittance of P-polarized light and a transmittance of S-polarized light, and

in ¼ of the wavelength range of wavelength 400 nm to 850 nm, or in other words, at a wavelength 112.5 nm or more, the broadband polarization separation configuration has achieved a difference of within 15% in high and low of transmittance.

Moreover, in two narrowband polarization separation configurations that are, a narrowband polarization separation configuration (1) and a narrowband polarization separation configuration (2), in ⅛ of the wavelength range of wavelength 400 nm to 850 nm, in other words, at a wavelength from 56.25 nm, a first narrowband polarization separation and a second narrowband polarization separation are achieved.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 400 nm to 850 nm, or in other words, 52 nm or more (56.25 nm).

Furthermore, in a configuration having the 19 layers of multilayer film combined, spectral characteristics of an angle of incidence 35° to 53° in FIG. 1 are shown. In such manner, the polarization separation characteristics are achieved in the wavelength range of 400 nm to 850 nm, at a wide angle of 35° to 53°.

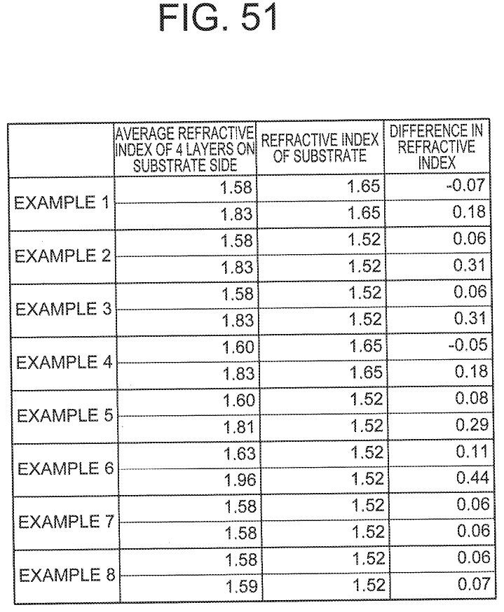

Moreover, an average refractive index of four layers from a light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

Moreover, as a material of the light transmissive substrate, it is possible to use an optical glass such as an alkali-free glass, a borosilicate glass, a fused quartz, a crystal, BK7 (commercial product name), Tempax (commercial product name) and the like, a crystalline material, a semiconductor substrate, and a synthetic resin.

Furthermore, for a material H of the first dielectric (high refractive index layer) and a material L of the second dielectric (low refractive index layer), it is possible to use a material in which at least two types of or more than two types are selected from TiO, TiO₂, Y₂O₃. Ta₂O₅, ZrO₂, Si, SiO₂, HfO₂, Ge, Nb₂O₅, Nb₂O₆, CeO₂, Cef₃, ZnS, ZnO, Fe₂O₃, MgF₂, AlF₃, CaF₂, LiF, Na₃AlF₆, Na₅AL₃F₁₄, A1₂O₃, MgO, LaF, PbF₂, NdF₃, or a mixture thereof.

Moreover, for a method of stacking two or more than two types of dielectrics of a material of the first dielectric and a material of the second dielectric, it is desirable to adopt any one of vacuum deposition and sputtering, physical film-thickness vapor deposition of ion plating, resistance heating vapor deposition, electron beam heating vapor deposition, high frequency heating vapor deposition, laser beam heating vapor deposition, ionization sputtering, ion beam sputtering, plasma sputtering, ion assist, and radical-assisted sputtering.

### Example 2

Next, an example 2 will be described below. Description of content overlapping with the content of the above mentioned example 1 will be omitted.

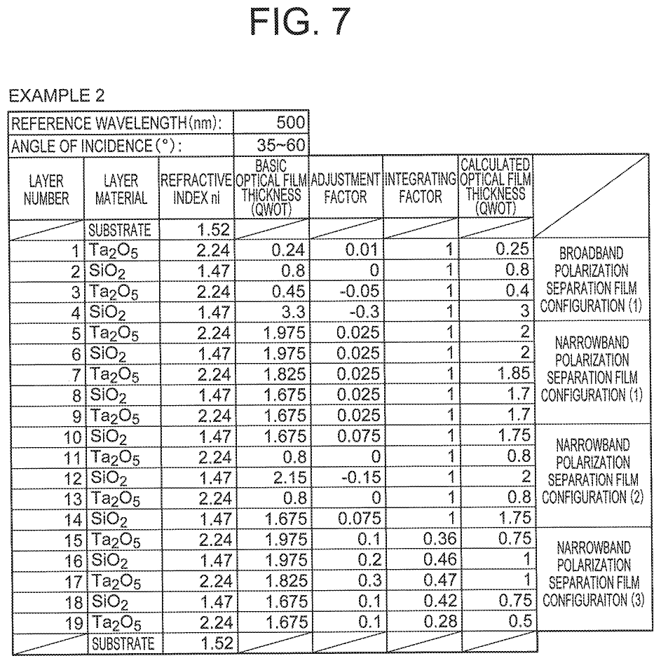

FIG. 7 is a table showing layer configuration of a polarization separation element according to the example 2. An optical film thickness is expressed as λ/4=1.0 (QWOT) when the reference wavelength is λ. The polarization separation element of the present example is a polarization separation film configuration having 19 layers stacked alternately. As shown in FIG. 7, the polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, and a nineteenth layer from a light transmissive substrate side at an upper side shown in FIG. 7. SiO₂ as a low refractive index material, is disposed in order of a second layer, a fourth layer, a sixth layer, an eighth layer, a tenth layer, a twelfth layer, a fourteenth layer, a sixteenth layer, and an eighteenth layer.

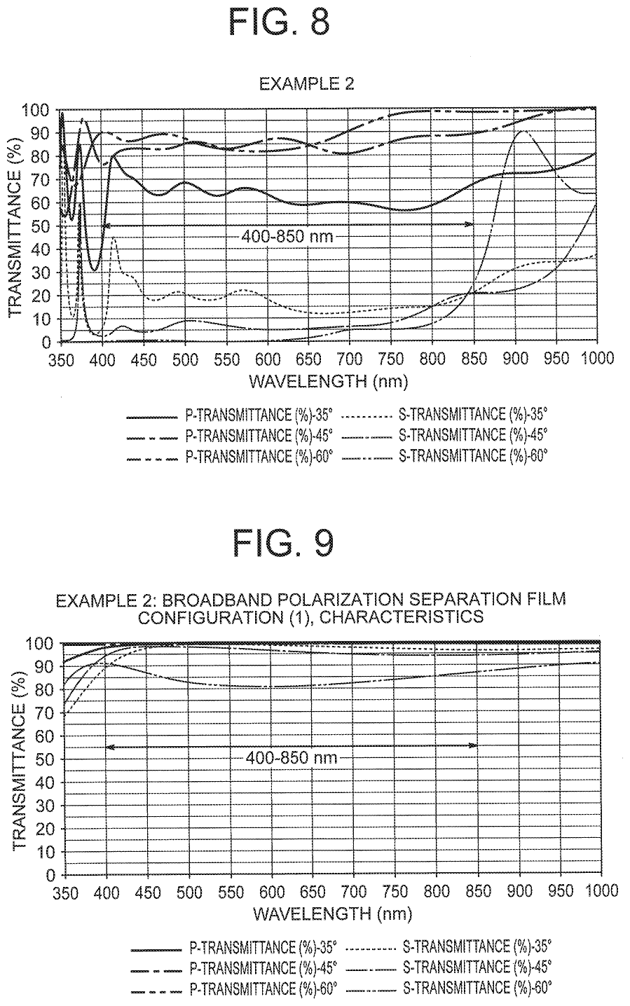

FIG. 8 is a diagram showing transmittance characteristics of the polarization separation element according to the example 2.

FIG. 9 is a diagram showing transmittance characteristics of a broadband polarization separation configuration (1) of the polarization separation element according to the example 2.

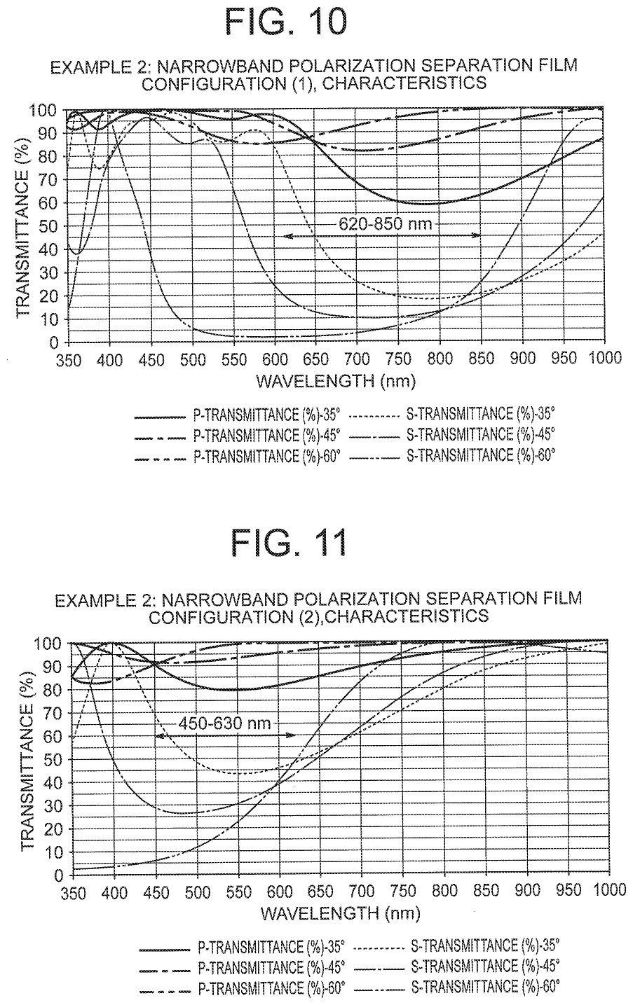

FIG. 10 is a diagram showing transmittance characteristics of a narrowband polarization separation configuration (1) of the polarization separation element according to the example 2.

FIG. 11 is a diagram showing transmittance characteristics of a narrowband polarization separation configuration (2) of the polarization separation element according to the example 2.

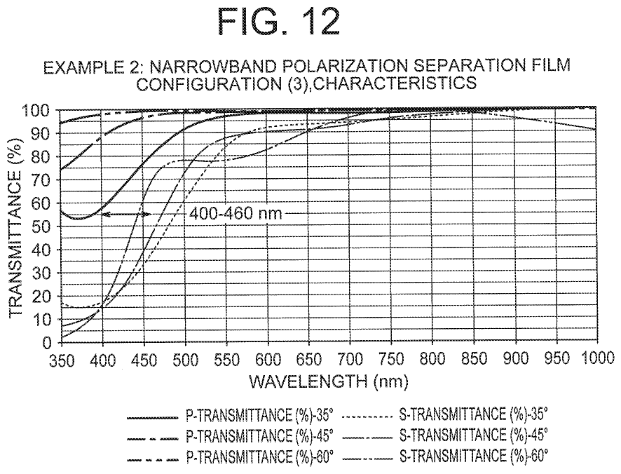

FIG. 12 is a diagram showing transmittance characteristics of a narrowband polarization separation configuration (3) of the polarization separation element according to the example 2.

In the example 2, in each configuration of the broadband polarization separation configuration,

in ½ of the wavelength range of wavelength 400 nm to 850 nm, or in other words, at a wavelength 225 nm or more, the broadband polarization separation configuration has achieved a difference of 10% or more in a transmittance of P-polarized light and a transmittance of S-polarized light, and

in ¼ of the wavelength range of wavelength 400 nm to 850 nm, or in other words, at a wavelength 112.5 nm or more, the broadband polarization separation configuration has achieved a difference of within in high and low of transmittance.

Moreover, the two of the narrowband polarization separation configuration (1) and the narrowband polarization separation configuration (2) have achieved a first narrowband polarization separation and a second narrowband polarization separation in ⅛ of the wavelength range of wavelength 400 nm to 850 nm, or in other words, at a wavelength 56.25 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 400 nm to 850 nm, or in other words, 52 nm or more (56.25 nm).

Furthermore, in a configuration having the 19 layers of multilayer film combined, spectral characteristics of an angle of incidence 35° to 60° in FIG. 8 are shown. In such manner, the polarization separation characteristics are achieved in the wavelength range of 400 nm to 850 nm, at a wide angle of 35° to 60°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

### Example 3

Next, an example 3 will be described below. Description of content overlapping with the content of the above mentioned examples will be omitted.

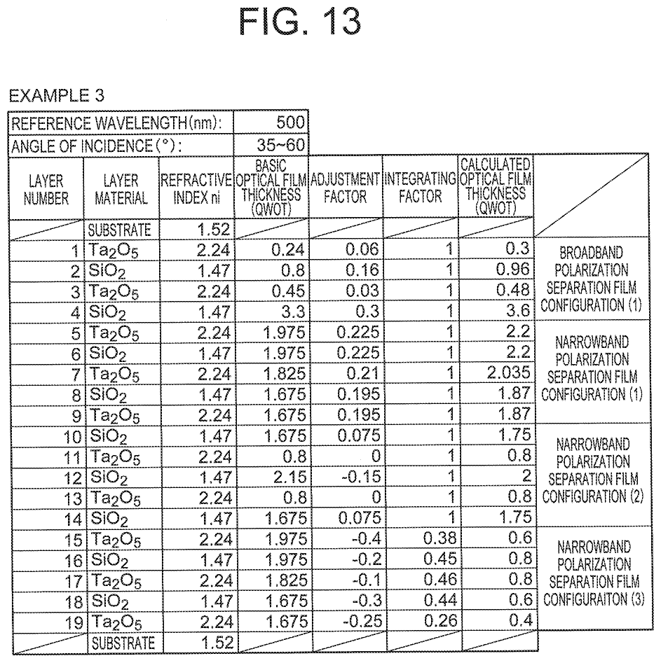

FIG. 13 is a table showing a layer configuration of a polarization separation element according to the example 3. An optical film thickness is expressed as λ/4=1.0 (QWOT) when the reference wavelength is λ. The polarization separation element of the present example is a polarization separation film configuration having 19 layers stacked alternately. As shown in FIG. 13, The polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, and a nineteenth layer from a light transmissive substrate side at an upper side shown in FIG. 13. SiO₂ as a low refractive index material, is disposed in order of a second layer, a fourth layer, a sixth layer, an eighth layer, a tenth layer, a twelfth layer, a fourteenth layer, a sixteenth layer, and an eighteenth layer.

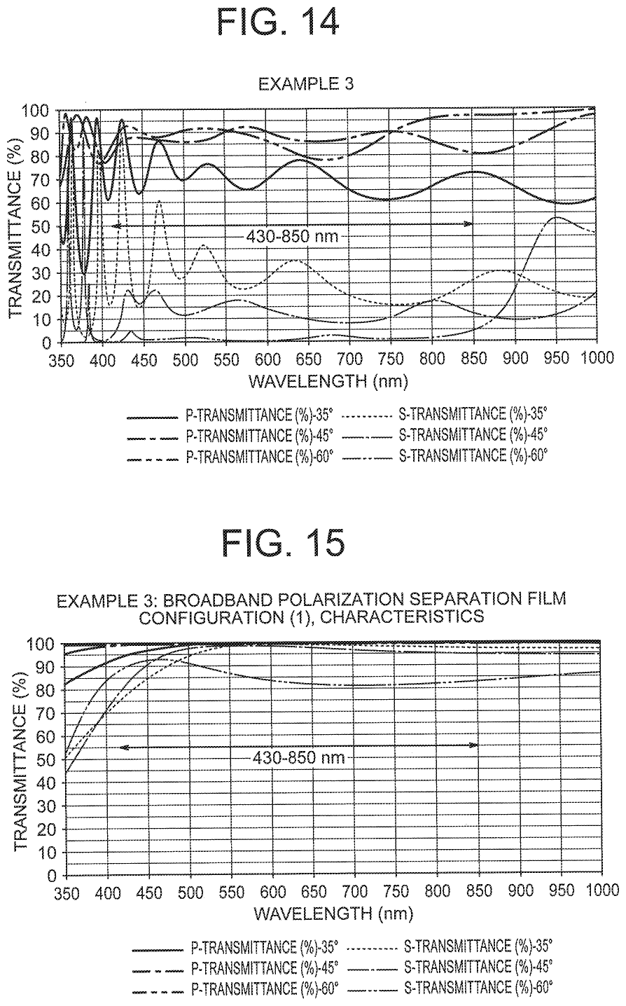

FIG. 14 is a diagram showing transmission characteristics of the polarization separation element according to the example 3.

FIG. 15 is a diagram showing transmittance characteristics of a broadband polarization separation configuration (1) of the polarization separation element according to the example 3.

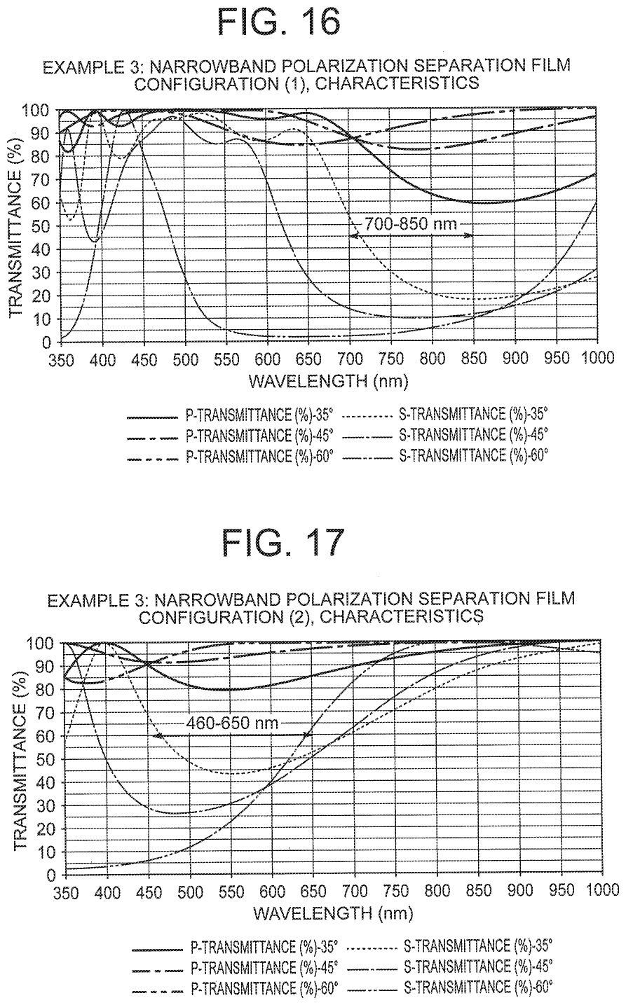

FIG. 16 is a diagram showing transmittance characteristics of a narrowband polarization separation configuration (1) of the polarization separation element according to the example 3.

FIG. 17 is a diagram showing transmittance characteristics of a narrowband polarization separation configuration (2) of the polarization separation element according to the example 3.

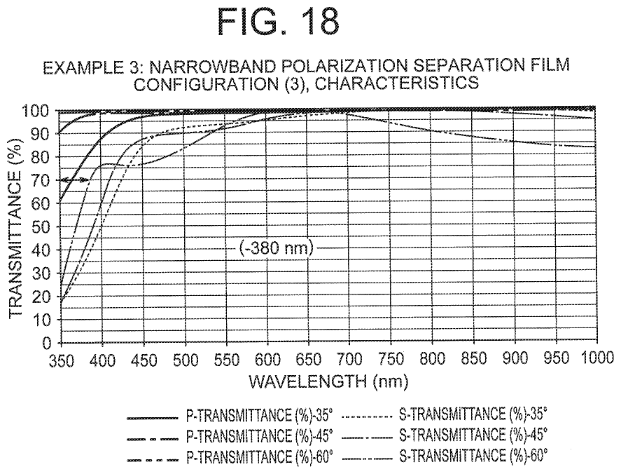

FIG. 18 is a diagram showing transmittance characteristics of a narrowband polarization separation configuration (3) of the polarization separation element according to the example 3.

In the example 3, in each configuration of the broadband polarization separation configuration,

in ½ of the wavelength range of wavelength 430 nm to 850 nm, or in other words, at a wavelength 210 nm or more, the broadband polarization separation configuration has achieved a difference of 10% or more in a transmittance of P-polarized light and a transmittance of S-polarized light, and

in ¼ of the wavelength range of wavelength 430 nm to 850 nm, or in other words, at a wavelength 105 nm and higher than 105 nm, the broadband polarization separation configuration has achieved a difference of within 15% in high and low of transmittance.

Moreover, the two of the narrowband polarization separation configuration (1) and the narrowband polarization separation configuration (2) have achieved a first narrowband polarization separation and a second narrowband polarization separation in ⅛ of the wavelength range of wavelength 430 nm to 850 nm, or in other words, at a wavelength 52.5 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 430 nm to 850 nm, or in other words, 52 nm or more (52.5 nm).

Furthermore, in a configuration having the 19 layers of multilayer film combined, spectral characteristics of an angle of incidence 35° to 60° in FIG. 14 are shown. In such manner, the polarization separation characteristics are achieved in the wavelength range of 430 nm to 850 nm, at a wide angle of 35° to 60°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

### Example 4

Next, an example 4 will be described below. Description of content overlapping with the content of the above mentioned examples will be omitted.

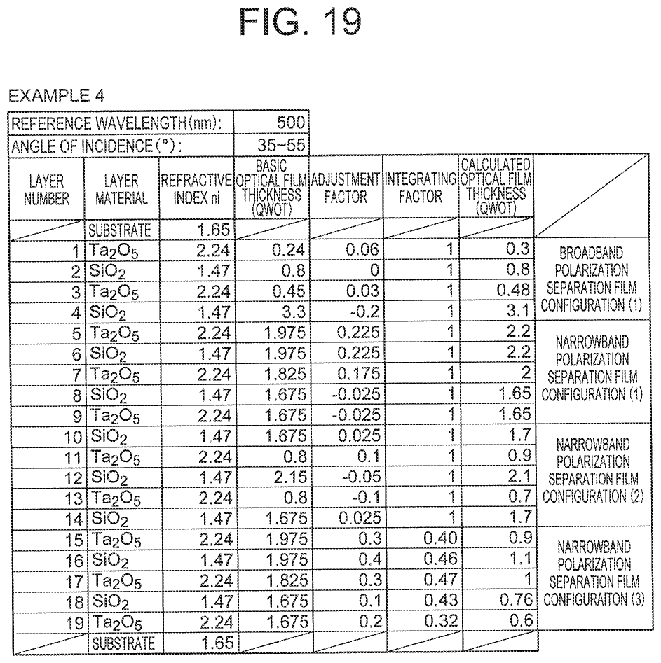

FIG. 19 is a table showing a layer configuration of a polarization separation element according to the example 4. An optical film thickness is expressed as λ/4=1.0 (QWOT) when a reference wavelength is λ. The polarization separation element of the present example is a polarization separation film configuration having 19 layers stacked alternately. As shown in FIG. 19, The polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, and a nineteenth layer from a light transmissive substrate side at an upper side shown in FIG. 19. SiO₂ as a low refractive index material, is disposed in order of a second layer, a fourth layer, a sixth layer, an eighth layer, a tenth layer, a twelfth layer, a fourteenth layer, a sixteenth layer, and an eighteenth layer.

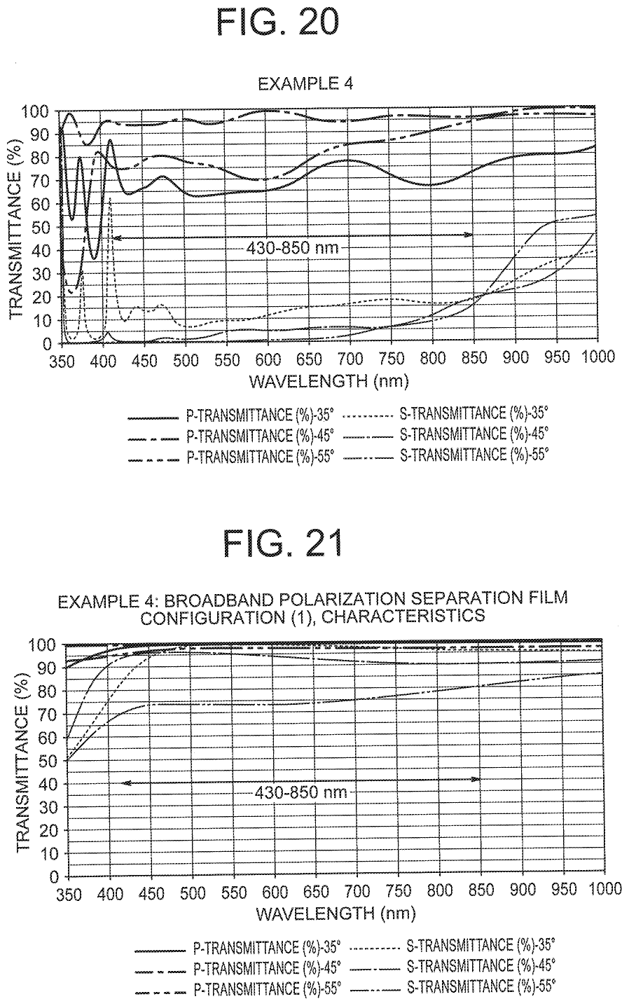

FIG. 20 is a diagram showing transmittance characteristics of the polarization separation element according to the example 4.

FIG. 21 is a diagram showing transmittance characteristics of a broadband polarization separation configuration (1) of the polarization separation element according to the example 4.

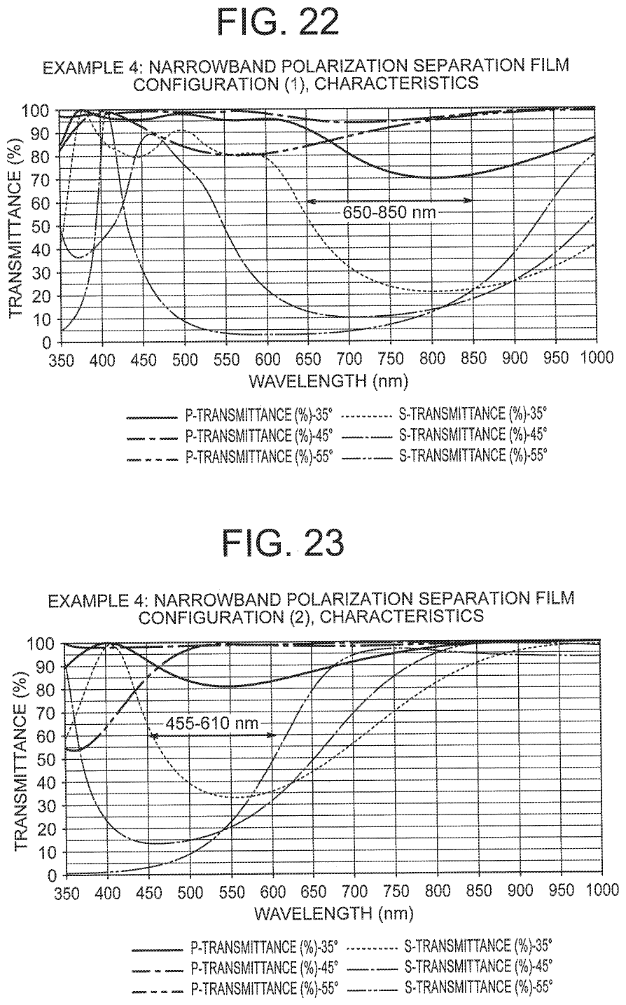

FIG. 22 is a diagram showing transmittance characteristics of a narrowband polarization separation configuration (1) of the polarization separation element according to the example 4.

FIG. 23 is a diagram showing transmittance characteristics of a narrowband polarization separation configuration (2) of the polarization separation element according to the example 4.

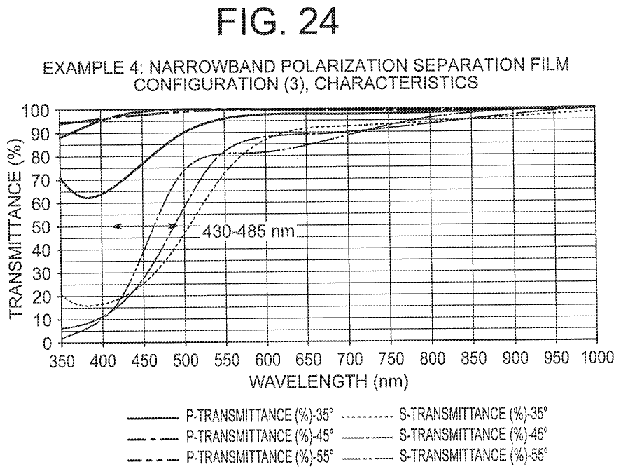

FIG. 24 is a diagram showing transmittance characteristics of a narrowband polarization separation configuration (3) of the polarization separation element according to the example 4.

In the example 4, in each configuration of the broadband polarization separation configuration, in ½ of the wavelength range of wavelength 430 nm to 850 nm, or in other words, at a wavelength 210 nm or more, the broadband polarization separation configuration has achieved a difference of 10% or more in a transmittance of P-polarized light and a transmittance of S-polarized light, and

in ¼ of the wavelength range of wavelength 430 nm to 850 nm, or in other words, at a wavelength 105 nm or more, the broadband polarization separation configuration has achieved a difference of within 15% in high and low of transmittance.

Moreover, the two of the narrowband polarization separation configuration (1) and the narrowband polarization separation configuration (2) have achieved a first narrowband polarization separation and a second narrowband polarization separation in ⅛ of the wavelength range of wavelength 430 nm to 850 nm, or in other words, at a wavelength 52.5 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 430 nm to 850 nm, or in other words, 52 nm or more (52.5 nm).

Furthermore, in a configuration having the 19 layers of multilayer film combined, spectral characteristics of an angle of incidence 35° to 55° in FIG. 20 are shown. In such manner, the polarization separation characteristics are achieved in the wavelength range of wavelength 430 nm to 850 nm, at a wide angle of 35° to 55°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

### Example 5

Next, an example 5 will be described below. Description of content overlapping with the content of the above mentioned examples will be omitted.

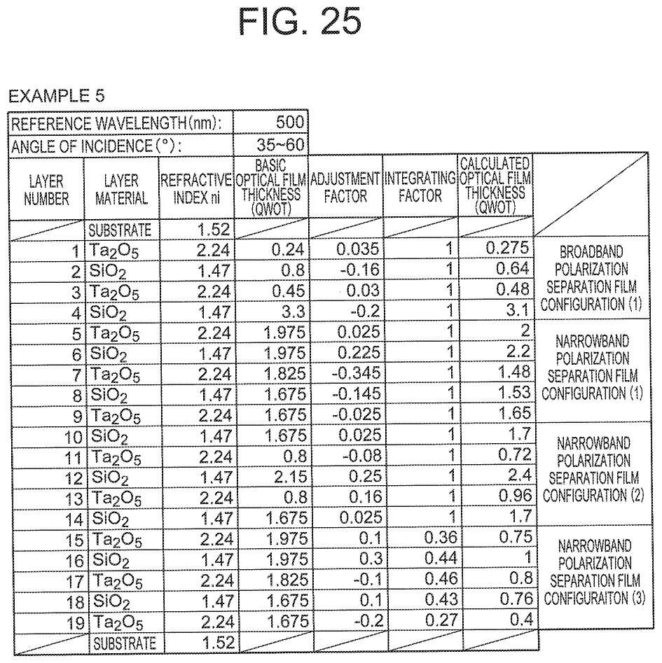

FIG. 25 is a table showing a layer configuration of a polarization separation element according to the example 5. An optical film thickness is expressed as λ/4=1.0 (QWOT) when a reference wavelength is λ. The polarization separation element of the present example is a polarization separation film configuration having 19 layers stacked alternately. As shown in FIG. 25, The polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, and a nineteenth layer from a light transmissive substrate side at an upper side shown in FIG. 25. SiO₂ as a low refractive index material, is disposed in order of a second layer, a fourth layer, a sixth layer, an eighth layer, a tenth layer, a twelfth layer, a fourteenth layer, a sixteenth layer, and an eighteenth layer.

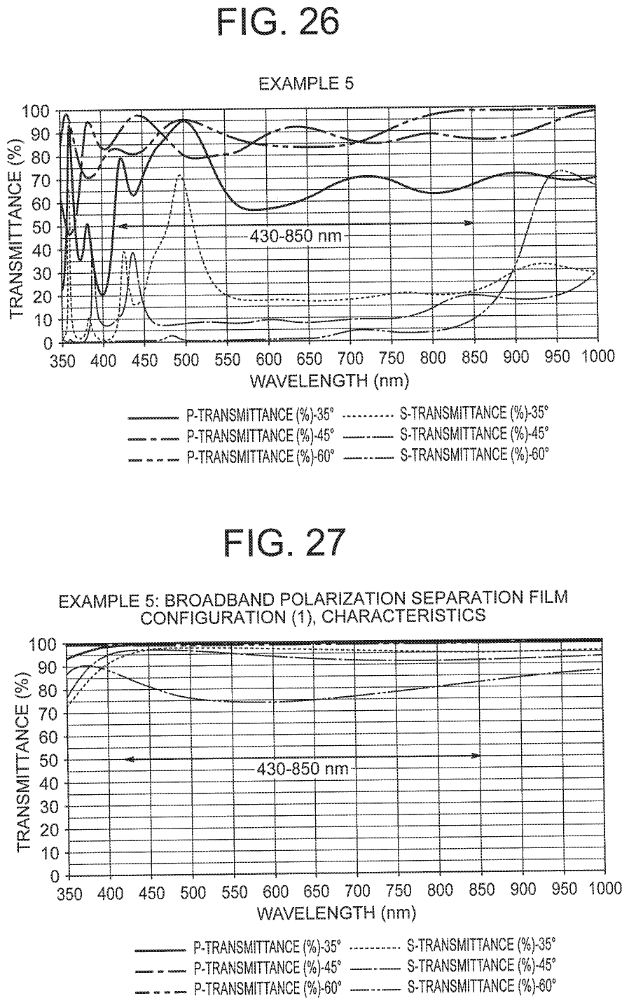

FIG. 26 is a diagram showing transmittance characteristics of the polarization separation element according to the example 5.

FIG. 27 is a diagram showing transmittance characteristics of a broadband polarization separation configuration (1) of the polarization separation element according to the example 5.

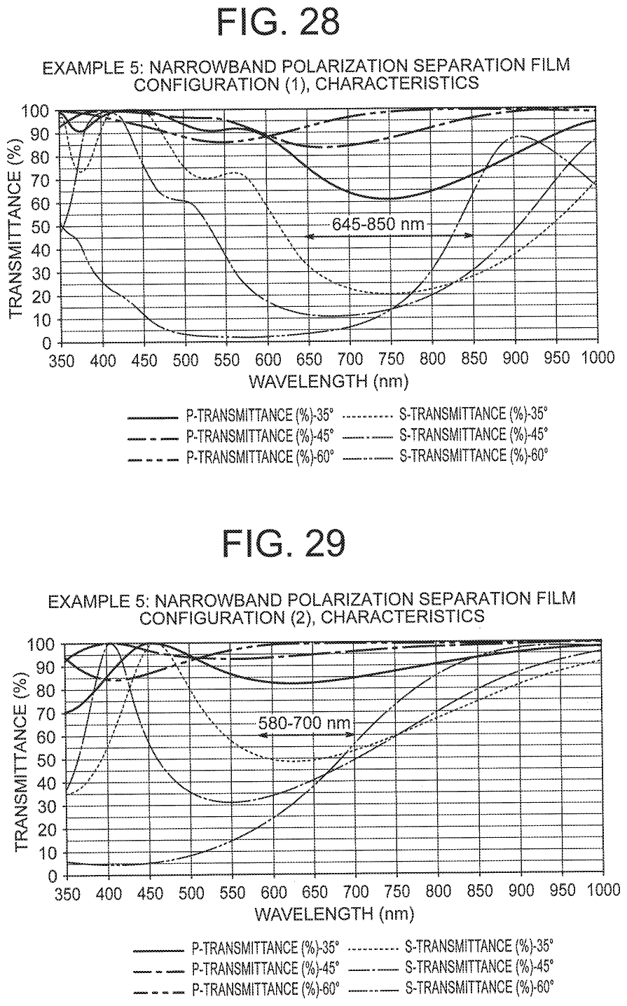

FIG. 28 is a diagram showing transmittance characteristics of a narrowband polarization separation configuration (1) of the polarization separation element according to the example 5.

FIG. 29 is a diagram showing transmittance characteristics of a narrowband polarization separation configuration (2) of the polarization separation element according to the example 5.

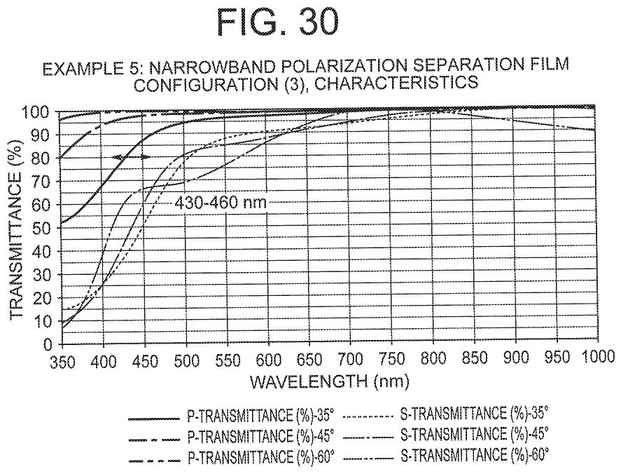

FIG. 30 is a diagram showing transmittance characteristics of a narrowband polarization separation configuration (3) of the polarization separation element according to the example 5.

In the example 5, in each configuration of the broadband polarization separation configuration,

in ½ of the wavelength range of wavelength 430 nm to 850 nm, or in other words, at a wavelength 210 nm a or more, the broadband polarization separation configuration has achieved a difference of 10% or more in a transmittance of P-polarized light and a transmittance of S-polarized light, and

in ¼ of the wavelength range of wavelength 430 nm to 850 nm, or in other words, at a wavelength 105 nm or more, the broadband polarization separation configuration has achieved a difference of within 15% in high and low of transmittance.

Moreover, the two of the narrowband polarization separation configuration (1) and the narrowband polarization separation configuration (2) have achieved a first narrowband polarization separation and second narrowband polarization separation in ⅛ of the wavelength range of wavelength 430 nm to 850 nm, or in other words, at a wavelength 52.5 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 430 nm to 850 nm, or in other words, 52 nm or more (52.5 nm).

Furthermore, in a configuration having the 19 layers of multilayer film combined, spectral characteristics of an angle of incidence 35° to 60° in FIG. 26 are shown. In such manner, the polarization separation characteristics are achieved in the wavelength range of wavelength 430 nm to 840 nm, at a wide angle of 35° to 60°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

### Example 6

Next, an example 6 will be described below. Description of content overlapping with the content of the above mentioned examples will be omitted.

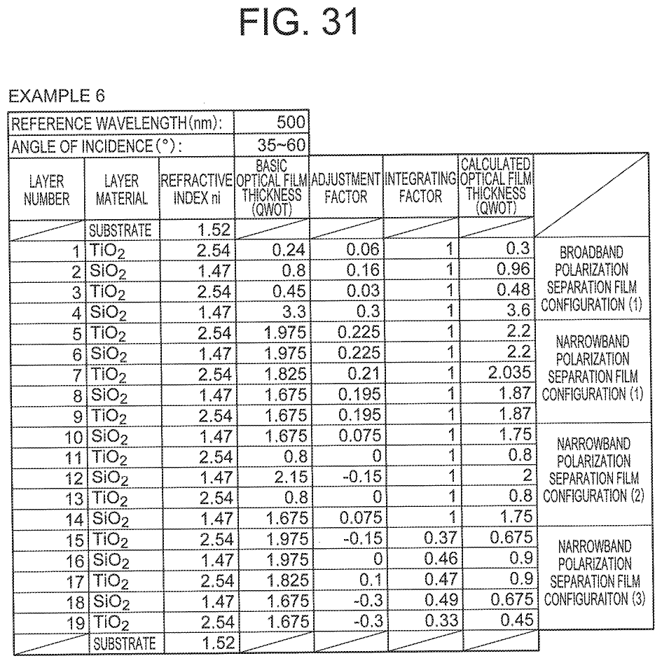

FIG. 31 is a table showing a layer configuration of a polarization separation element according to the example 6. An optical film thickness is expressed as λ/4=1.0 (QWOT) when a reference wavelength is λ. The polarization separation element of the present example is a polarization separation film configuration having 19 layers stacked alternately. As shown in FIG. 31, the polarization separation element has a multilayer film formed by stacking SiO₂ (refractive index nL=1.47) as a low refractive index material and TiO₂ (refractive index nH=2.54) as a high refractive index material alternately on a light transmissive substrate.

TiO₂ as a high refractive index material, is disposed in order of a first layer, a third layer, a fifth layer, a seventh layer, a ninth layer, an eleventh layer, a thirteenth layer, a fifteenth layer, a seventeenth layer, and a nineteenth layer from a light transmissive substrate side at an upper side shown in FIG. 31. SiO₂ as a low refractive index material, is disposed in order of a second layer, a fourth layer, a sixth layer, an eighth layer, a tenth layer, a twelfth layer, a fourteenth layer, a sixteenth layer, and an eighteenth layer.

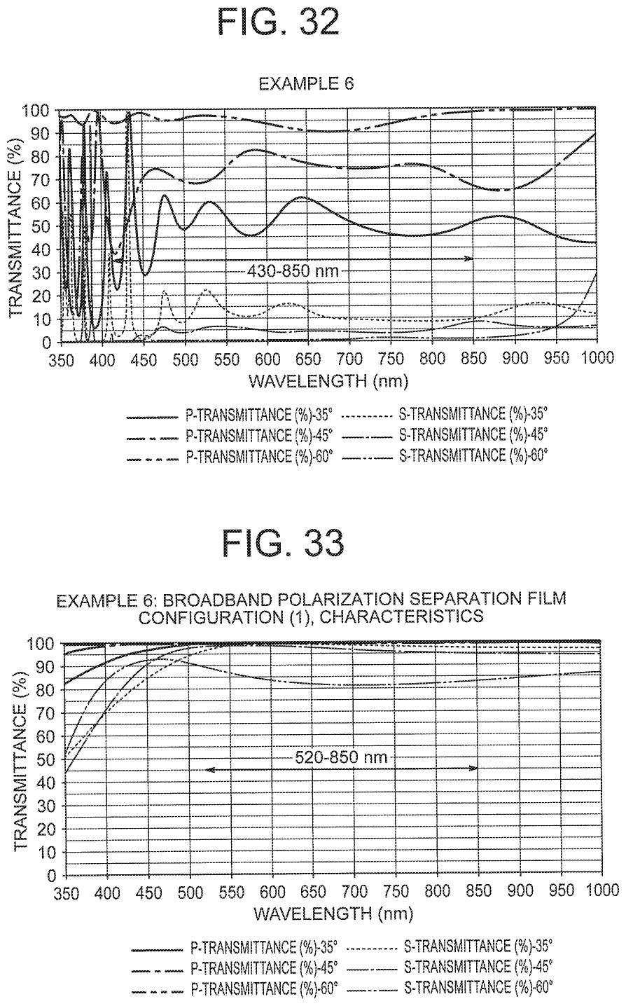

FIG. 32 is a diagram showing transmittance characteristics of the polarization separation element according to the example 6.

FIG. 33 is a diagram showing transmittance characteristics of a broadband polarization separation configuration (1) of the polarization separation element according to the example 6.

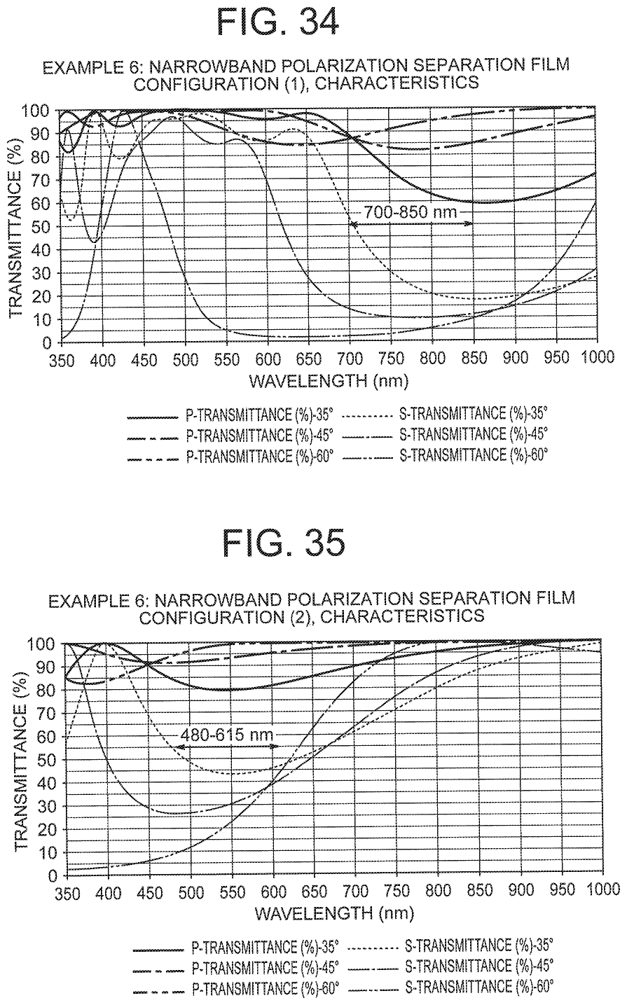

FIG. 34 is a diagram showing transmittance characteristics of a narrowband polarization separation configuration (1) of the polarization separation element according to the example 6.

FIG. 35 is a diagram showing transmittance characteristics of a narrowband polarization separation configuration (2) of the polarization separation element according to the example 6.

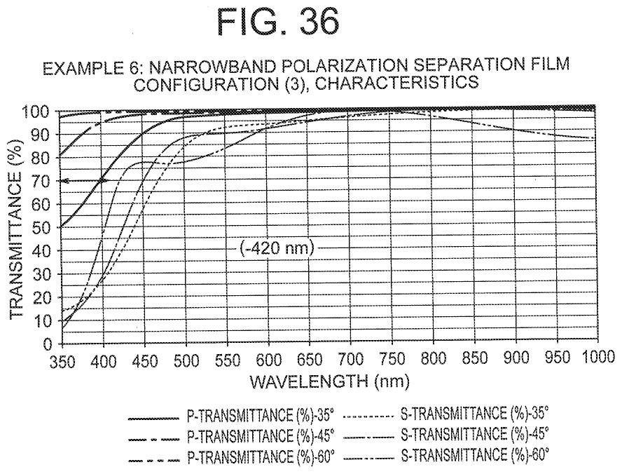

FIG. 36 is a diagram showing transmittance characteristics of a narrowband polarization separation configuration (3) of the polarization separation element according to the example 6.

In the example 6, in each configuration of the broadband polarization separation configuration, in ½ of the wavelength range of wavelength 430 nm to 850 nm, or in other words, at a wavelength 210 nm or more, the broadband polarization separation configuration has achieved a difference of 10% or more than in a transmittance of P-polarized light and a transmittance of S-polarized light, and

in ¼ of the wavelength range of wavelength 430 nm to 850 nm, or in other words, at a wavelength 105 nm and higher than 105 nm, the broadband polarization separation configuration has achieved a difference of within 15% in high and low of transmittance.

Moreover, the two of the narrowband polarization separation configuration (1) and the narrowband polarization separation configuration (2) have achieved a first narrowband polarization separation and a second narrowband polarization separation in ⅛ of the wavelength range of wavelength 430 nm to 850 nm, or in other words, at a wavelength 52.5 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 430 nm to 850 nm, or in other words, 52 nm or more (52.5 nm).

Furthermore, in a configuration having the 19 layers of multilayer film combined, spectral characteristics of an angle of incidence 35° to 60° in FIG. 32 are shown. In such manner, the polarization separation characteristics are achieved in the wavelength range of wavelength 430 nm to 840 nm, at a wide angle of 35° to 60°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

### Example 7

Next, an example 7 will be described below. Description of content overlapping with the content of the above mentioned examples will be omitted.

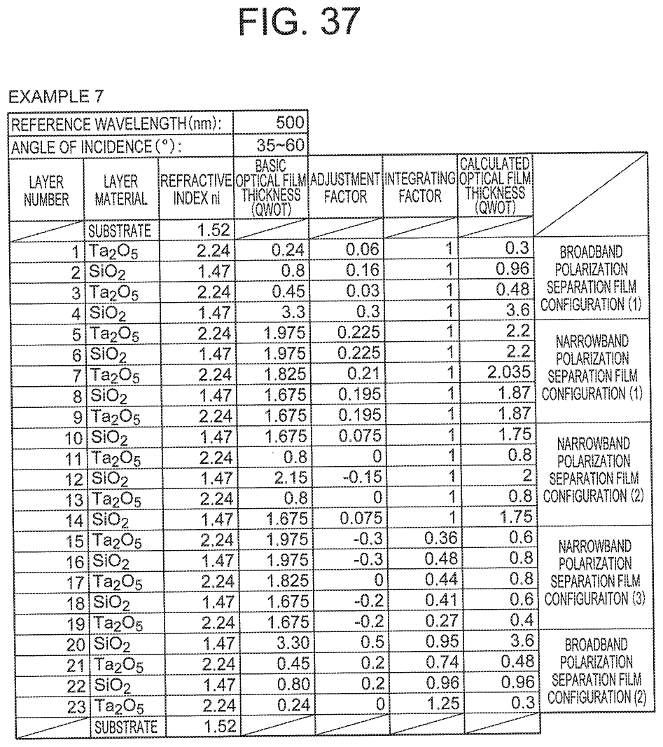

FIG. 37 is a table showing a layer configuration of a polarization separation element according to the example 7. An optical film thickness is expressed as λ/4=1.0 (QWOT) when a reference wavelength is λ. The polarization separation element of the present example is a polarization separation film configuration having 23 layers stacked alternately. As shown in FIG. 37, The polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, a nineteenth layer, a twenty first layer, and a twenty third layer from a light transmissive substrate side at an upper side shown in FIG. 37. SiO₂ as a low refractive index material, is disposed in order of a second layer, a fourth layer, a sixth layer, an eighth layer, a tenth layer, a twelfth layer, a fourteenth layer, a sixteenth layer, an eighteenth layer, a twentieth layer, and a twenty second layer.

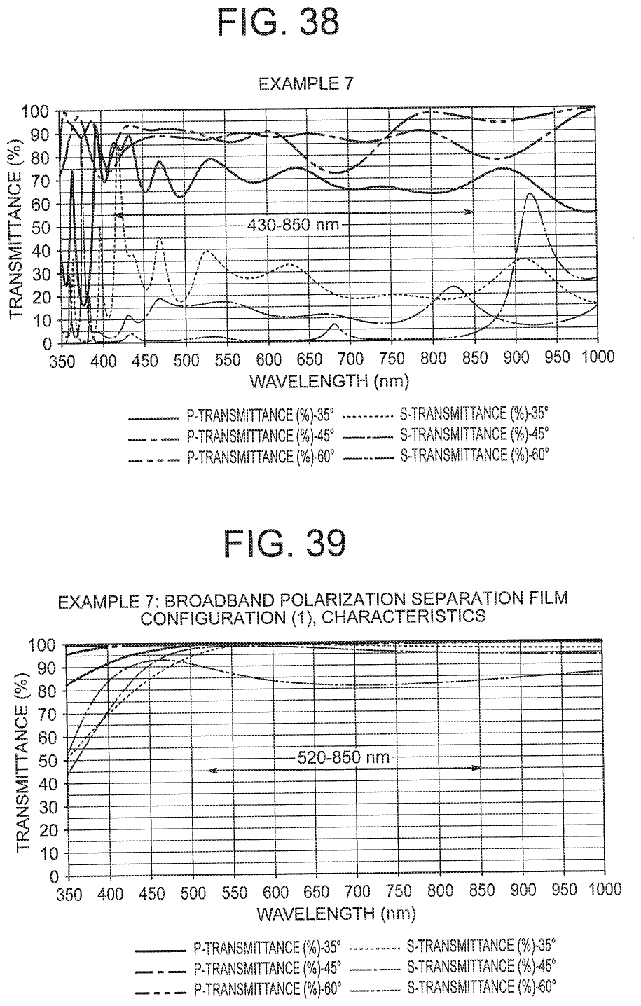

FIG. 38 is a diagram showing transmittance characteristics of the polarization separation element according to the example 7.

FIG. 39 is a diagram showing transmittance characteristics of a broadband polarization separation configuration (1) of the polarization separation element according to the example 7.

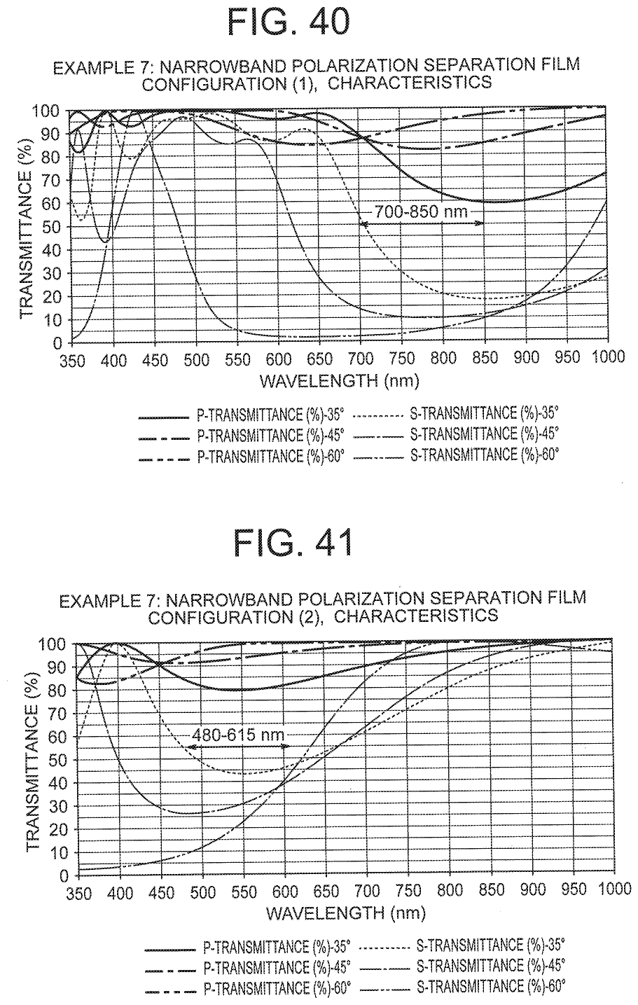

FIG. 40 is a diagram showing transmittance characteristics of a narrowband polarization separation configuration (1) of the polarization separation element according to the example 7.

FIG. 41 is a diagram showing transmittance characteristics of a narrowband polarization separation configuration (2) of the polarization separation element according to the example 7.

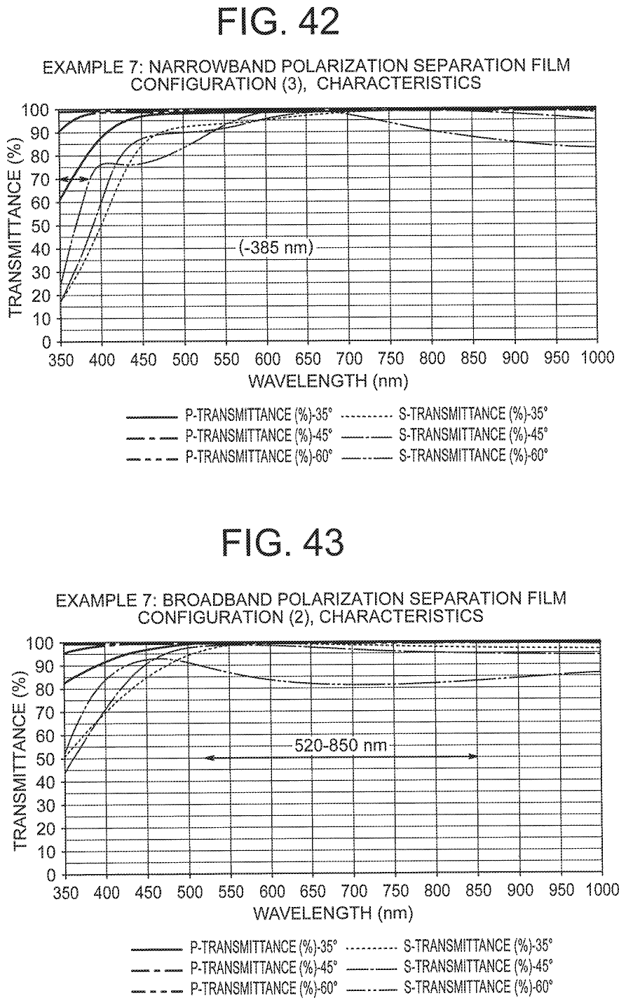

FIG. 42 is a diagram showing transmittance characteristics of a narrowband polarization separation configuration (3) of the polarization separation element according to the example 7.

FIG. 43 is a diagram showing transmittance characteristics of a broadband polarization separation configuration (2) of the polarization separation element according to the example 7.

In the example 7, in each configuration of the broadband polarization separation configuration,

in ½ of the wavelength range of wavelength 430 nm to 850 nm, or in other words, at a wavelength 210 nm or more, the broadband polarization separation configuration has achieved a difference of 10% or more in a transmittance of P-polarized light and a transmittance of S-polarized light, and

in ¼ of the wavelength range of wavelength 430 nm to 850 nm, or in other words, at a wavelength 105 nm or more, the broadband polarization separation configuration has achieved a difference of within 15% in high and low of transmittance.

Moreover, the two of the narrowband polarization separation configuration (1) and the narrowband polarization separation configuration (2) have achieved a first narrowband polarization separation and a second narrowband polarization separation in ⅛ of the wavelength range of wavelength 430 nm to 850 nm, or in other words, at a wavelength 52.5 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 430 nm to 850 nm, or in other words, 52 nm or more (52.5 nm).

Furthermore, in a configuration having the 23 layers of multilayer film combined, spectral characteristics of an angle of incidence 35° to 60° in FIG. 38 are shown. In such manner, the polarization separation characteristics are achieved in the wavelength range of wavelength 430 nm to 850 nm, at a wide angle of 35° to 60°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

### Example 8

Next, an example 8 will be described below. Description of content overlapping with the content of the above mentioned examples will be omitted.

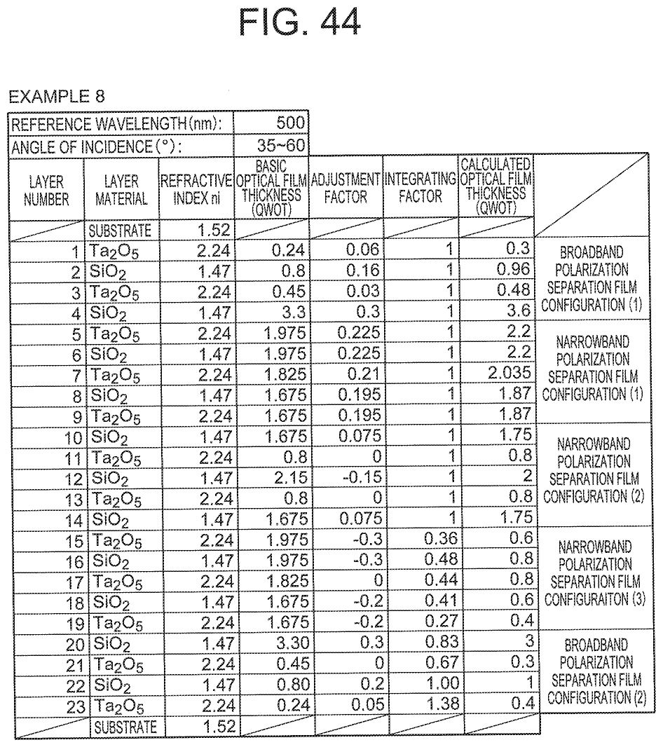

FIG. 44 is a table showing a layer configuration of a polarization separation element according to the example 8. An optical film thickness is expressed as λ/4=1.0 (QWOT) when a reference wavelength is λ. The polarization separation element of the present embodiment is a polarization separation film configuration having 23 layers stacked alternately. As shown in FIG. 44, the polarization separation element has a multilayer film formed by stacking SiO₂ (refractive index nL=1.47) as a low refractive index material and Ta₂O₅ (refractive index nH=2.24) as a high refractive index material alternately on a light transmissive substrate.

Ta₂O₅ as a high refractive index material, is disposed in order of a first layer, a third layer, a fifth layer, a seventh layer, a ninth layer, an eleventh layer, a thirteenth layer, a fifteenth layer, a seventeenth layer, a nineteenth layer, a twenty first layer, and a twenty third layer from a light transmissive substrate side at an upper side shown in FIG. 14. SiO₂ as a low refractive index material, is disposed in order of a second layer, a fourth layer, a sixth layer, an eighth layer, a tenth layer, a twelfth layer, a fourteenth layer, a sixteenth layer, an eighteenth layer, a twentieth layer, and a twenty second layer.

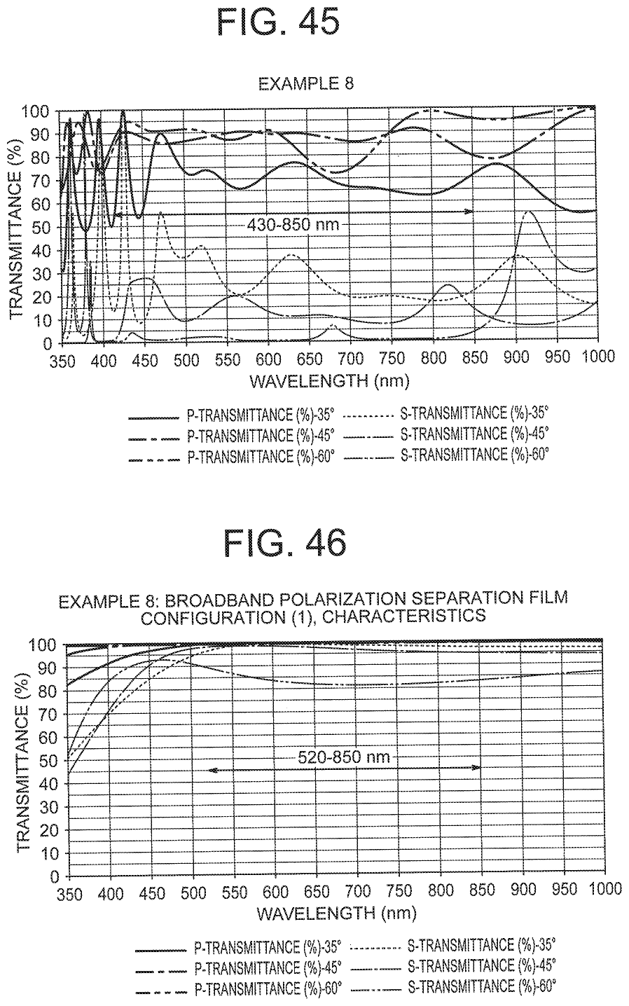

FIG. 45 is a diagram showing transmittance characteristics of the polarization separation element according to the example 8.

FIG. 46 is a diagram showing transmittance characteristics of a broadband polarization separation configuration (1) of the polarization separation element according to the example 8.

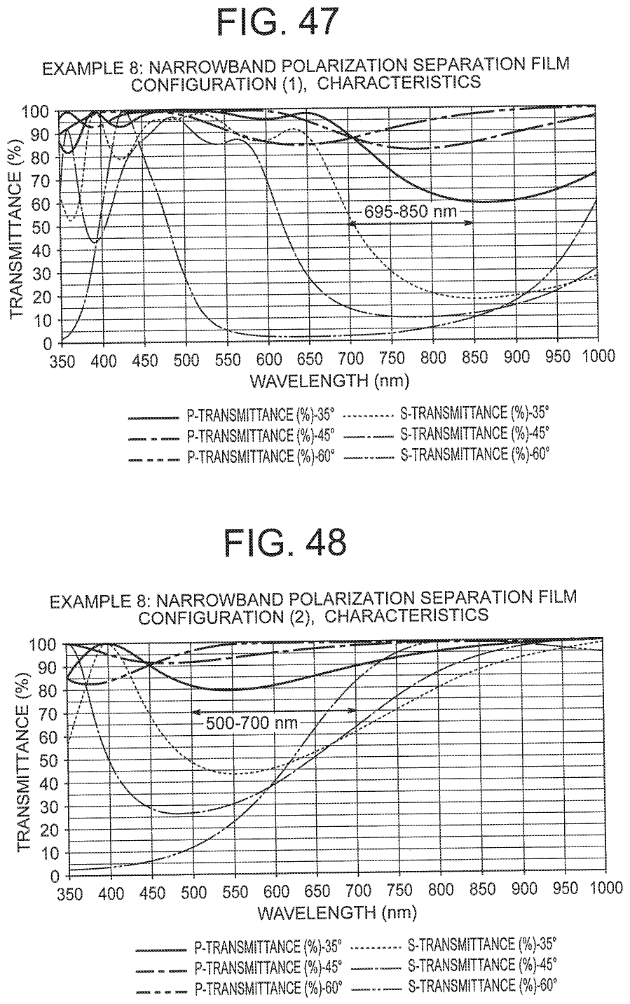

FIG. 47 is a diagram showing transmittance characteristics of a narrowband polarization separation configuration (1) of the polarization separation element according to the example 8.

FIG. 48 is a diagram showing transmittance characteristics of a narrowband polarization separation configuration (2) of the polarization separation element according to the example 8.

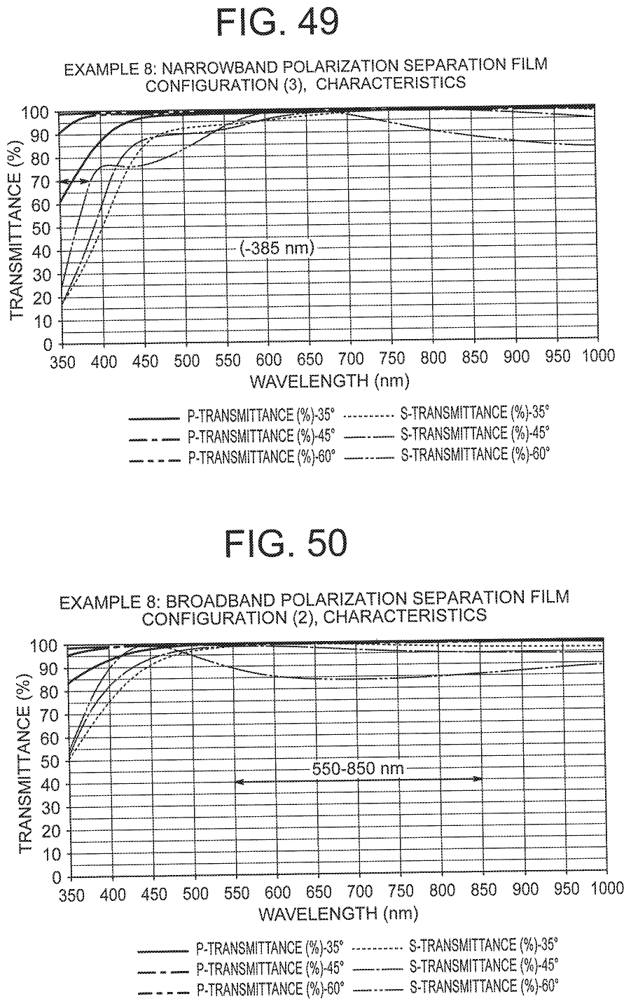

FIG. 49 is a diagram showing transmittance characteristics of a narrowband polarization separation configuration (3) of the polarization separation element according to the example 8.

FIG. 50 is a diagram showing transmittance characteristics of a broadband polarization separation configuration (2) of the polarization separation element according to the example 8.

In the example 8, in each configuration of the broadband polarization separation configuration,

in ½ of the wavelength range of wavelength 430 nm to 850 nm, or in other words, at a wavelength 210 nm or more, the broadband polarization separation configuration has achieved a difference of 10% or more in a transmittance of P-polarized light and a transmittance of S-polarized light, and

in ¼ of the wavelength range of wavelength 430 nm to 850 nm, or in other words, at a wavelength 105 nm or more, the broadband polarization separation configuration has achieved a difference of within 15% in high and low of transmittance.

Moreover, the two of the narrowband polarization separation configuration (1) and the narrowband polarization separation configuration (2) have achieved a first narrowband polarization separation and a second narrowband polarization separation in ⅛ of the wavelength range of wavelength 430 nm to 850 nm, or in other words, at a wavelength 52.5 nm.

Furthermore, the narrowband polarization separation has achieved polarization separation characteristics of a transmittance Tp of P-polarized light higher than a transmittance Ts of S-polarized light (Tp>Ts), and a difference between Tp and Ts is 30% or more, in ⅛ of the wavelength range of wavelength 430 nm to 850 nm, or in other words, 52 nm or more (52.5 nm).

Furthermore, in a configuration having the 23 layers of multilayer film combined, spectral characteristics of an angle of incidence 35° to 60° in FIG. 45 are shown. In such manner, the polarization separation characteristics are achieved in the wavelength range of wavelength 430 nm to 850 nm, at a wide angle of 35° to 60°.

Moreover, an average refractive index of four layers from the light transmissive substrate side in a multilayer film structure in contact with a pair of light transmissive substrates at both sides is shown in FIG. 51. It is revealed that, in the present example, it is within a range of ±0.2 with respect to a refractive index of the light transmissive substrate.

In the examples 7 and 8, the broadband polarization separation film configuration is arranged at a position in contact with each of the two light transmissive substrates (first substrate and second substrate).

Table 1 below, shows a wavelength bandwidth in the examples 1 to 8.

Table 2 is a numerical example showing that the structure of alternately stacked dielectrics has the broadband polarization separation film configuration having spectral characteristics such that, each of a transmittance height difference TTp of the P-polarized light and a transmittance height difference TTs of the S-polarized light is at most within 15%, in a section of wavelength section range which is at least ¼ of the entire wavelength section.

Table 3 is a numerical example showing that the structure of alternately stacked dielectrics, in a first wavelength range narrower than a wavelength range included in the entire section of wavelength, has a narrowband polarization separation film configuration having spectral characteristics such that, the transmittance Tp of the P-polarized light and the transmittance Ts of the S-polarized light differ by at least 30% or more, in a wavelength range which is at least ⅛ of the entire section of wavelength.

FIG. 4 is a numerical example showing that the structure of alternately stacked dielectrics has a broadband polarization film configuration having spectral characteristics such that a difference in the transmittance Tp of the P-polarized light and the transmittance Ts of the S-polarized light is 10% or more, in a section of wavelength range which is at least ½ of the entire section of wavelength.

TABLE 1
unit: nm

| | Entire section A1-A2 | Broadband(1) | Narrowband(1) |
|---|---|---|---|
| Example1 | 400-850 | 400-850 | 620-850 |
| Example2 | 400-850 | 400-850 | 620-850 |
| Example3 | 430-850 | 430-850 | 700-850 |
| Example4 | 430-850 | 430-850 | 650-850 |
| Example5 | 430-850 | 430-850 | 645-850 |
| Example6 | 430-850 | 520-850 | 700-850 |
| Example7 | 430-850 | 520-850 | 700-850 |
| Example8 | 430-850 | 520-850 | 695-850 |

| | Narrowband(2) | Narrowband(3) | Broadband(2) |
|---|---|---|---|
| Example1 | 450-630 | 400-460 | — |
| Example2 | 450-630 | 400-460 | — |
| Example3 | 460-650 | (−380) | — |
| Example4 | 455-610 | 430-485 | — |
| Example5 | 580-700 | 430-460 | — |
| Example6 | 480-615 | (−420) | — |
| Example7 | 480-615 | (−385) | 520-850 |
| Example8 | 500-700 | (−385) | 550-850 |

Where, figures shown in brackets of the narrowband (3) are outside the range of A1-A2.

TABLE 2
unit: nm
Range in which, a difference in the maximum
and the minimum for each λ/4 is ‘within 15%’.

Incidence angle (degree)

| | 35 | 35 | 45 | 45 | 60 | 60 |
|---|---|---|---|---|---|---|
| | P | S | P | S | P | S |
| Example1 | 440 | 439 | 450 | 450 | 450 | 336 |
| Example2 | 420 | 420 | 420 | 420 | 420 | 306 |
| Example3 | 191 | 194 | 420 | 420 | 238 | 420 |
| Example4 | 420 | 420 | 420 | 420 | 420 | 420 |
| Example5 | 311 | 327 | 387 | 404 | 420 | 420 |
| Example6 | 191 | 382 | 402 | 420 | 420 | 420 |
| Example7 | 350 | 342 | 420 | 282 | 191 | 382 |
| Example8 | 363 | 205 | 420 | 237 | 123 | 420 |

TABLE 3
unit: nm
Wavelength range ‘differing by 30% or
more’ in each narrowband wavelength range

| | Wavelength range | Wavelength Range/8 |
|---|---|---|
| Example1 | 400-850 nm | 56.25 |
| Example2 | 400-850 nm | 56.25 |
| Example3 | 430-850 nm | 52.5 |
| Example4 | 430-850 nm | 52.5 |
| Example5 | 430-850 nm | 52.5 |
| Example6 | 430-850 nm | 52.5 |
| Example7 | 430-850 nm | 52.5 |
| Example8 | 430-850 nm | 52.5 |

| | Narrowband1 | Narrowband2 | Narrowband3 |
|---|---|---|---|
| Example1 | 230 | 180 | 60 |
| Example2 | 230 | 180 | 60 |
| Example3 | 150 | 190 | — |
| Example4 | 200 | 155 | 55 |
| Example5 | 205 | 120 | 30 |
| Example6 | 150 | 135 | — |
| Example7 | 150 | 135 | — |
| Example8 | 155 | 200 | — |

TABLE 4
unit: nm
Wavelength range ‘differing by 10% or
more’ in each broadband wavelength range

| | Wavelength | Wavelength | | |
|---|---|---|---|---|
| | Range | Range/2 | Broadband1 | Broadband2 |
| Example1 | 400-850 nm | 225 | 450 | — |
| Example2 | 400-850 nm | 225 | 450 | — |
| Example3 | 430-850 nm | 210 | 420 | — |
| Example4 | 430-850 nm | 210 | 420 | — |
| Example5 | 430-850 nm | 210 | 420 | — |
| Example6 | 430-850 nm | 210 | 330 | — |
| Example7 | 430-850 nm | 210 | 330 | 330 |
| Example8 | 430-850 nm | 210 | 330 | 300 |

### (Prism Element)

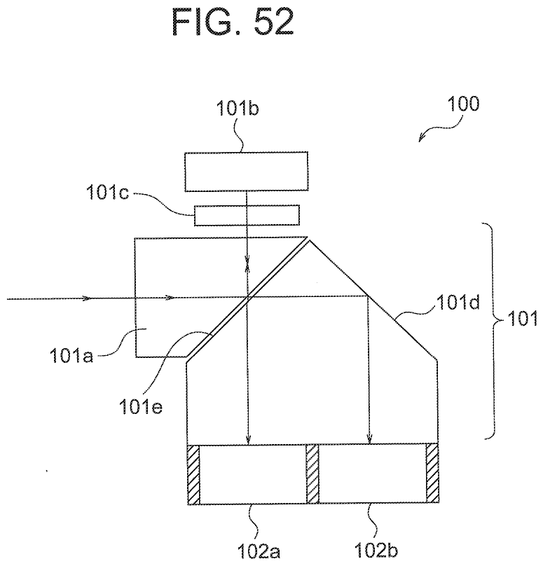

Next, a prism element having the polarization separation element according to the above mentioned examples will be described below. FIG. 52 is a diagram showing a configuration of a prism element 100 having the polarization separation element according to each example.

The prism element 100 includes a prism unit 101, a λ/4 plate 101c, a reflecting mirror 101b, and an image sensor 102a. The prism unit 101 further includes prisms 101a and 101d.

Here, a polarization separation element 101e of each above mentioned example is formed on an inclined surface between the prism 101a and the prism 101d.

Out of light incident on the prism 101a from a left side of a diagram, P-polarized light is transmitted through the polarization separation element 101e, and after being reflected at a prism inclined surface, is incident on the image sensor 102b.

Whereas, out of light incident on the prism 101a from the left side the diagram, S-polarized light is reflected at the polarization separation element 101e toward the reflecting mirror 101b. Light reflected at the reflecting mirror 101b is transmitted twice, back and forth, through the λ/4 plate 101c, and a direction of polarization is changed to P-polarized light. The P-polarized light is transmitted through the polarization separation element 101e, and is incident on the image sensor 102a.

Accordingly, an effect is shown that in an element splitting the light incident into two optical paths, in a wide wavelength region, it is possible to achieve favorable characteristics enabling to deal with a wide range of angles of incidence by a simple multilayer film (stacked film).

### (Optical System)

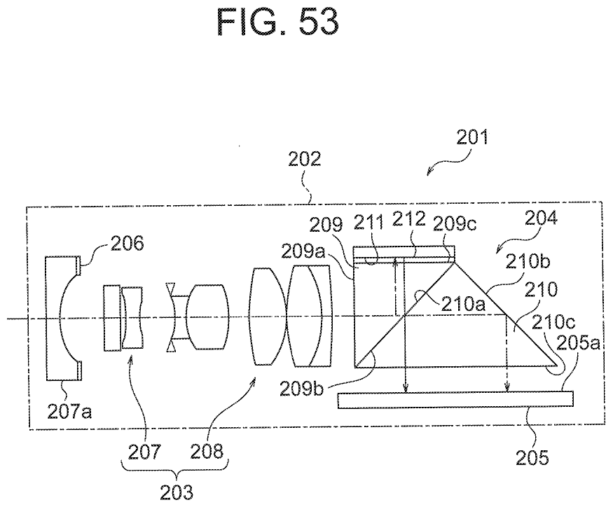

Next, an optical system having the polarization separation element according to each example will be described below. FIG. 53 is a diagram showing a configuration of an optical system according to an example 9. The present embodiment is an optical system for an endoscope.

An endoscope 201 according to the present embodiment, as shown in FIG. 53, includes an objective optical system 203 disposed inside an insertion unit 202 to be inserted into a body to be examined, an optical path splitting unit 204 that spits light focused by the objective optical system 203 into two optical paths, an image sensor 205 that acquires two images by picking up simultaneously light split by the optical path splitting unit 204, and a flare aperture (shielding unit) 206 that partially cuts out two optical images formed on the image sensor 205.

The objective optical system 203, as shown in FIG. 53, includes in order from an object side, a positive lens group 208 and a negative lens group 207 including a planoconcave negative lens 207a having a flat surface directed toward the object side. An arrangement is such that, light refracted by the negative lens group 207 from a wide field range, after being focused by the positive lens group 208, is output toward the optical path splitting unit 204 in the subsequent stage.

The optical path splitting unit 204 is configured by combining two small and large triangular prisms, a first prism 209 and a second prism 210, a mirror 211, and a λ/4 plate 212. The first prism 209 has a first surface 209a orthogonal to an optical axis of the objective optical system 203, a second surface 209b making an angle of 45° with the optical axis, and a third surface 209c parallel to the optical axis. The second prism 210 has a first surface 210a and a second surface 210b making an angle of 45° with the optical axis of the objective optical system, and a third surface 210c parallel to the optical axis. The first surface 210a and the second surface 210b of the second prism 210 are mutually orthogonal.

The first surface 209a of the first prism 209 is a surface of incidence on which a light beam incoming from the objective optical system 203 is made to be incident. A polarization separation surface is formed by interposing and bringing in close contact without leaving any space a polarization separation film (omitted in the diagram) between the second surface 209b of the first prism 209 and a first surface 210a of the second prism 210. The second surface 210b of the second prism 210 forms a deflection surface which deflects light travelled in an optical axial direction through the second prism 210 by 90°.

The mirror 211 is disposed to be interposed between the third surface 209c of the first prism 209 and the λ/4 plate 212. Accordingly, a light beam emerged from the objective optical system 203, after being incident on the first prism 209 from the first surface 209a of the first prism 209, is separated into P-polarized light (light transmitted) and S-polarized light (light reflected) at the polarization separation surface (209b and 210a) having the polarization separation film disposed thereon.

The light reflected at the polarization separation surface (209b and 210a), upon being made to be transmitted through the λ/4 plate 212 from the third surface 209c of the first prism 209, is deflected to be returned through 180°, and upon being made to be retransmitted through the λ/4 plate 212, the polarization angle is turned by 90°, and then, upon being transmitted through the polarization separation film, is emerged to outside from the third surface 210c of the second prism 210. Whereas, the light transmitted through the polarization separation surface (209b and 210a) travels through the second prism 210, and upon being polarized by 90° at the second surface 210b of the second prism 210, is emerged to outside from the third surface 210c of the second prism 210.

After being incident through the first prism 201 from the first surface 209a of the first prism 209 till emerging from the third surface 210c of the second prism 210, an optical path length of light travelling along two optical paths split has a slight optical path difference d of about several μm to tens of μm for example. Accordingly, focusing positions of optical images by two light beams incident on the image sensor 205 disposed face-to-face with the third surface 210c of the second prism 210 differ slightly.

The image sensor 205 has an image pickup surface 205a made to face the third surface 210c of the second prism 210 leaving a parallel space, and the two light beams emerged from the third surface 210c of the second prism 210 are made to be incident simultaneously. In other words, the image sensor 205, for picking up simultaneously the two optical images with different focusing positions, has two rectangular-shaped light receiving areas (effective pixel areas) in an overall pixel area of the image sensor 205.

Accordingly, in the optical system that splits the incident light for endoscope into two optical paths, an effect is shown that it is possible to achieve favorable characteristics dealing with a wide range of angles of incidence by a simple multilayer film (stacked film).

### (Optical Instrument)

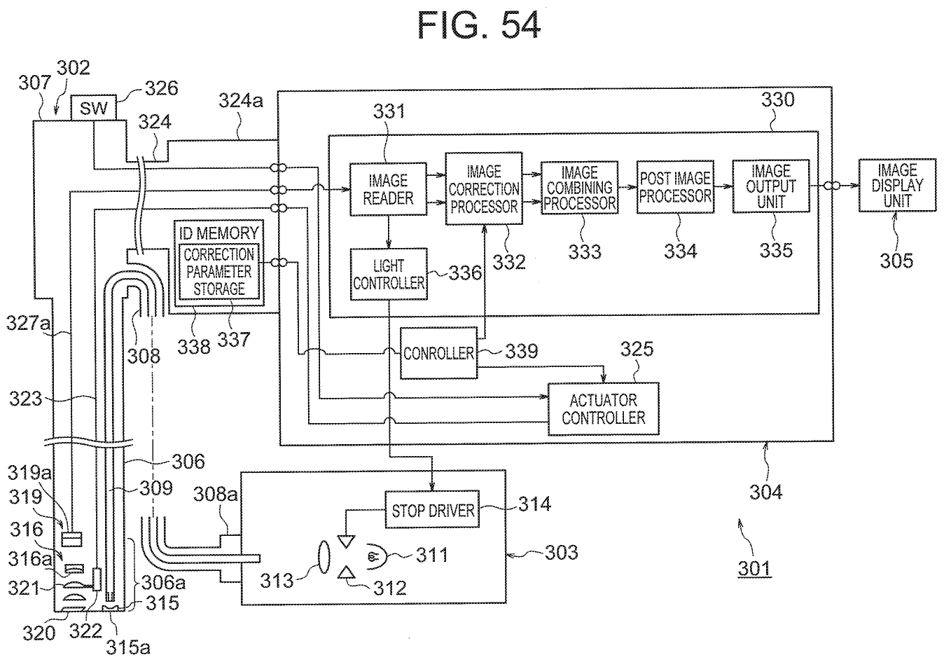

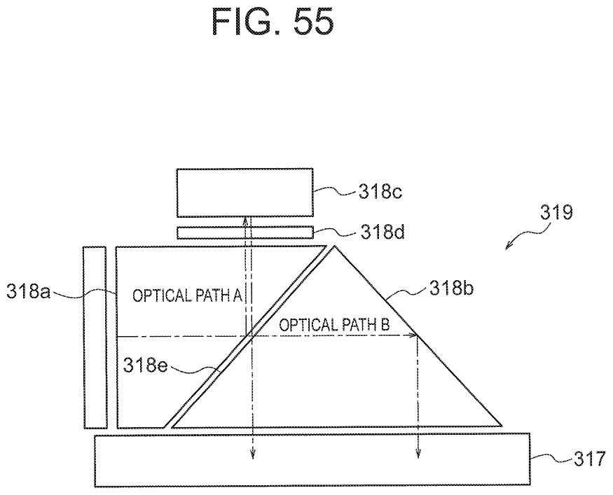

Next, an optical instrument having the polarization separation element according to each above mentioned example will be described below. FIG. 54 is a diagram showing a configuration of an optical instrument according to an example 10. Moreover, FIG. 55 is a diagram showing a polarization beam splitter of an endoscope system. The present endoscope system has the above mentioned objective optical system for endoscope.

As shown in FIG. 54, an endoscope system 301 of the present embodiment includes an endoscope 302 to be inserted into a body to be examined, a light source 303 supplying illumination light to the endoscope 302, a processor 304 that carries out image processing of an image signal acquired by an image sensor provided to the endoscope 302, and an image display unit 305 that displays the image signal subjected to a predetermined image processing by the processor 304, as an endoscope image.

The endoscope 302 includes an insertion unit 306 which is long and slender, to be inserted into the body to be examined, an operating unit 307 provided at a rear end of the insertion unit 306, and a first cable 308 extended from the operating unit 307. A light guide 309 that transmits illumination light is inserted into the first cable 309.

A distal end 306a of the insertion unit 306 of the endoscope 302 is provided with an illumination lens 315 that diffuses illumination light emerged from the light guide 309, an objective optical system 316 that acquires an object image, and an image pickup unit 319a that picks up the object image. A light guide connector 308a at an end unit of the first cable 308 is detachably connected to the light source 303 such that, a rear end of the light guide 309 inserted into the first cable 308 becomes an incident end of illumination light.

The light source 303 has a lamp 311 such as xenon lamp built-in as a light source. As the light source, without restricting to the lamp 311 such as xenon lamp, a light-emitting diode (abbreviated as LED) may be used.

White light generated by the lamp 311, after having an amount of light passing adjusted by a stop 312, is focused by a condenser lens 313 and is incident (supplied) on an incident end surface of the light guide 309. An amount of opening of the stop 312 is varied by a stop driver 314.

The light guide 309 guides illumination light incident on the incident end (rear end side) from the light source 303 toward the distal end 306a of the insertion unit 306. The illumination light guided to the distal end 306a, upon being diffused by the illumination lens 315 disposed on a distal end surface of the distal end 306a from an emergence end (distal end side) of the light guide, is emerged via an illumination window 315a, and illuminates a part of an object observed inside the body to be examined.

An object image of the part of an object observed which is illuminated is formed by the objective optical system 316 attached to an observation window 320 provided to be adjacent to the illumination window 315a of the distal end 306a, on an image sensor 317 (FIG. 55) disposed on a rear side thereof.

The objective optical system 316 includes an optical element group 316a consisting of a plurality of optical elements, a focusing lens 321 as a focus switching mechanism that selectively adjusts focus to two observation areas of distant observation and proximity observation, and an actuator 322 that drives a focusing lens 321.

The image pickup unit 319a has a polarization beam splitter 319 provided at a rear end side of the insertion unit 306 of the objective optical system 316, which splits an object image into two optical images of different focus, and the image sensor 317 that acquires two images by picking up the two optical images.

The polarization beam splitter 319, as shown in FIG. 55, includes a first prism 318a, a second prism 318b, a mirror 318c, and a λ/4 plate 318d. Both the first prism 318a and the second prism 318b have a beam splitting surface inclined at 45° with respect to an optical axis, and the beam splitting surface of the first prism 318a is provided with a polarization separation film 318e. Moreover, the polarization beam splitter 319 is formed by bringing the beam splitting surfaces of the first prism 318a and the second prism 318b in contact via the polarization separation film 318e of each example. Moreover, the mirror 318c is provided near an end surface of the first prism 318a via the λ/4 plate 318d, and the image sensor 317 is attached to an end surface of the second prism 318b.

An object image from the objective optical system 316 is separated into a P-polarization component (light transmitted) and an S-polarization component (light reflected) by the polarization separation film 318e provided to the beam splitting surface of the first prism 318a, and is separated into two optical images, an optical image on the reflected light side and an optical image on the transmitted light side.

The optical image of the S-polarization component is reflected toward an opposite surface side with respect to the image sensor 317 at the polarization separation film 318e and travels along an optical path A, and upon being transmitted through the λ/4 plate 318d, is returned toward the image sensor 317 at the mirror 318c. The optical image returned has an angle of polarization turned through 90° by being retransmitted through the λ/4 plate 318d, and upon being transmitted through the polarization separation film 318e, is formed on the image sensor 317.

The optical image of P-polarized light is transmitted through the polarization separation film 318e and travels along an optical path B, and upon being reflected at a mirror surface provided on an opposite side of the beam splitting surface of the second prism 318b that returns perpendicularly toward the image sensor 317, is formed as an image on the image sensor 317. At this time, an optical path in glass of prism is set such that a predetermined optical path difference of tens of μm for instance, is generated in the optical path A and the optical path B, and two optical images having a different focus are made to be formed on a light receiving surface of the image sensor 317.

In other words, the first prism 318a and the second prism 318b are disposed such that an optical path length on a reflected-light side becomes short (small) with respect to an optical path length (path length in glass) on a transmitted-light side reaching the image sensor 317 in the first prism 318a in order to enable to separate an object image into two optical images having different focusing positions.

The image sensor 317, for picking up separately each of the two optical images with difference focusing positions, is provided with two light receiving areas (effective pixel areas) in the overall pixel area of the image sensor 317. The two light receiving areas, for picking up the two optical images, are disposed to coincide with image forming surfaces of these optical images respectively. Moreover, in the image sensor 317, the one light receiving area has the focusing position thereof shifted relatively toward a near-point side with respect to the other light receiving area, and the other light receiving area has the focusing position thereof shifted relatively toward a far-point side with respect to the one light receiving area. Accordingly, the two optical images having different focus are formed on the light receiving surfaces of the image sensor 317.

The focusing position with respect to the two light receiving areas may be shifted relatively by changing an optical path length reaching the image sensor 317 by making differ a refractive index of both in the first prism 318a and the second prism 318b.

Moreover, a correction pixel area for correcting a geometrical shift of the optical image split into two is provided around the light receiving area of the image sensor 317. By suppressing a manufacturing error in the correction pixel area and by carrying out correction by image processing in an image correction processor 332 that will be described later, the geometrical shift of the optical images is eliminated.

The focusing lens 321 is movable to two positions in a direction of an optical axis, and is driven to move from one position to the other position and from the other position to the one position between two positions by the actuator 322. In a state of the focusing lens 321 set to a position at an anterior side (object side), the setting is made such that an object in an observation area in a case of distant observation is focused, and in a state of the focusing lens 321 set to a position at a posterior side, the setting is such that an object in an observation area in a case of a proximity observation is focused.

The actuator 322 is connected to a signal wire 323 inserted into the insertion unit 306, and this signal wire 323 is further inserted through a second cable 324 extended from an operating unit 307. A signal connector 324a of an end of the second cable 324 is detachably connected to the processor 304, and the signal wire 323 is connected to an actuator controller 325 provided inside the processor 304.

The actuator controller 325 also inputs a switching operation signal from a switching operation switch 326 provided to the operating unit 307 of the endoscope 302 for example. The actuator controller 325 applies a drive signal that electrically drives the actuator 322 according to an operation of the switching operation switch 326 and moves the focusing lens 321.

A switching operation unit that generates the switching operation signal, without being restricted to the switching operation switch 326, may be a switching operation lever. A focus switching mechanism is formed by the focusing lens 321, the actuator 322, and the actuator controller 325. Incidentally, the focusing unit in the present embodiment is not restricted to a unit that moves the focusing lens in the above mentioned optical axial direction. It may be a switching unit that switches the focus by inserting and removing a lens and a filter into and from the objective optical system.

The image sensor 317 is connected to the insertion unit 306, the operating unit 307, and the signal wire 327a inserted through the second cable 324; and the signal connector 324 by being connected to the processor 304, is connected to an image processor 330 as the image processor provided inside the processor 304.

The image processor 330 includes an image reader 331 that reads respective images of the two optical images having different focusing positions, picked up by the image sensor 317, the image correction processor 332 that carries out image correction on two images read by the image reader 331, and an image combining processor 333 that carries out image combining processing of combining the two images corrected.

The image correction processor 332 corrects images according to the two optical images formed respectively in the two light receiving areas of the image sensor 317 such that, the mutual difference other than the focus is substantially same. In other words, the correction of two images is carried out such that the relative position, angle, and magnification in each optical image of the two images are substantially same.

In a case of separating the object image into two, and forming each of the two images on the image sensor 317, a geometrical difference occurs in some cases. In other words, there occurs a relative shift in magnification, shift in position, shift in angle, or in other words, shift in direction of rotation and the like, in the respective optical images formed in the two light receiving areas of the image sensor 317 in some cases. It is difficult to eliminate these differences entirely at the time of manufacturing, and when an amount of these shifts becomes large, the combined image becomes a double image, and an unnatural unevenness of brightness and the like occurs. Therefore, the above mentioned geometrical difference and the unevenness of brightness are corrected in the image correction processor 332.

The image combining processor 333 selects images with relatively high contrast in a corresponding predetermined area between the two images corrected by the image correction processor 332, and generates a combined image. In other words, the image combining processor 333 compares contrast in each spatially same pixel area in two images, and by selecting a pixel area with relatively high contrast, generates a combined image as one image combined from the two images. In a case in which, a difference in contrast of the same pixel areas in two images is small or substantially same, the image combining processor 333 generates a combined image by a predetermined combined image processing of weighting and adding in that pixel area.

Moreover, the image processor 330 has a post image processor 334 that carries out post image processing such as color matrix processing, outline enhancement, gamma correction and the like on an image combined by the image combining processor 333, and an image output unit 335 that outputs an image subjected to post image processing, and an image output from the image output unit 335 is displayed on an image display unit 305.

Furthermore, the image processor 330 has a light controller 336 that generates a light control signal for controlling the light to a reference brightness from an image read by the image reader 331, and outputs the light control signal generated by the light controller 336 to the stop driver 314. The stop driver 314, according to the light control signal, adjusts an amount of opening of the stop 312 to maintain the reference brightness.

Moreover, in the present embodiment, in the image correction processor 332, a correction parameter storage 337 storing (information of) correction parameters to be used in a case of correcting an image is provided.

The endoscope 302 has an ID memory 338 having stored endoscope identification information (endoscope ID) specific to that endoscope 302, and in a case in which there are specific correction parameters to be corrected in that endoscope 302, the endoscope 302 is provided with the correction parameter storage 337 in which correction parameters corresponding to the endoscope 302 are stored.

Here, the correction parameter refers to occurrence of the above mentioned geometrical difference and difference of brightness, or a difference of color in an image according to two optical images due to wavelength characteristics of λ/4 plate and shading characteristics of an optical-path splitting element and an image sensor. When there is such difference between two images, since an unnatural unevenness in brightness and unevenness in color occur in the combined image, the correction parameter is determined upon taking into consideration characteristics of an optical-path splitting element, an image sensor, and a λ/4 plate for correcting the unevenness.

An arrangement may be made such that the correction parameters set in advance in the image correction processor 332 are received from the correction parameter storage 337, and the correction is carried out. It is also possible to make an arrangement such that, at the time of shipping from the factory, the amount of shift is set in advance in the correction parameter storage 337, and when the endoscope 302 is connected to the image processor 330, upon identifying that the endoscope 302 has been connected, the corresponding parameters are retrieved from the correction parameter storage 337 and the correction is carried out for example.

In a case in which there is no specific correction parameter to be corrected, it is unnecessary to provide the correction parameter storage 337. Moreover, the correction parameter storage 337 is not restricted to be provided inside the ID memory and may be provided in a memory separate from the ID memory 338.

Moreover, a controller 339 of the image processor 330 identifies whether or not there is a correction by an endoscope ID provided on the endoscope side 302, and in a case in which there is a correction, the controller 339 reads the correction parameter form the correction parameter storage 337 in the ID memory 338 stored on the endoscope 302 side, and sends this correction parameter to the image correction processor 332.

The image correction processor 332 carries out image correction suitable for the image pickup unit 319a installed in each endoscope 302, on the basis of the correction parameter forwarded from the controller 339.

Moreover, the image correction processor 332, by using the correction parameters, carries out correction of an image such as correction of the above mentioned difference in magnification and correction of the difference in position, with one of the two images as a reference image. For instance, in a case in which a shift in magnification occurs in two images, it is due to specifications of objective optical system 316.

In a case in which a size of the objective optical system 316 is to be made comparatively small, sometimes the design is carried out such that a light ray toward the image sensor 317 disrupts telecentricity and is incident obliquely. For instance, when an angle made with an optical axis is an angle of incidence, clockwise rotation is plus, and an anticlockwise rotation is minus, a design is carried out such that the angle of incidence becomes minus.

In such objective optical system in which the telecentricity is disrupted, when the focusing position is shifted, the shift in magnification occurs between the two images.

When the design specifications are such, the amount of shift is to be kept stored in advance in the correction parameter storage 337, and in a case in which the target endoscope 302 is connected to the processor 304, an arrangement is made such that the endoscope 302 is identified, and corresponding correction parameters are retrieved from the correction parameter storage 337, and the correction is carried out.

Sometimes, relative positions of pixels of two images are shifted minutely at the time of assembling the image pickup unit 319a. In this case, the amount of shift at the time of manufacturing is to be kept stored in the correction parameter storage 337, and the correction of shift is to be carried out in the image correction processor 332. For correction of the shift in position, processing in which a reading position of two images is adjusted such that relative positions of an image picked up in one light receiving area of the image sensor 317 and an image picked up in the other light receiving area coincide, is carried out, and after the shift in position is corrected, it is output to the image combining processor 333.

Instead of carrying out the correction by correction parameters set in advance in the present embodiment, at the time of using the endoscope, correction may be carried out by a reference chart for adjustment prepared separately. An arrangement may be made such that the reference chart is disposed at a desired position at the distal end of the endoscope 302, and the shift in the two images with respect to the reference chart is read in the image correction processor, and the shift is corrected.

Accordingly, an effect is shown that, in an endoscope system, in a wide wavelength region, two images with favorable characteristics dealing with a wide range of angles of incidence by a simple multilayer film (stacked film) are achieved, and it is possible to achieve an image having a large depth of field by combining these two images.

In the above mentioned polarization separation element, a plurality of configurations may be satisfied simultaneously. Doing so is preferable for achieving a favorable polarization separation element, a method of designing a polarization separation element, an optical system, and an optical instrument.

Various embodiments of the present disclosure have been described heretofore. However, the present disclosure is not restricted to these embodiments, and embodiments in which the configurations of these embodiments are combined appropriately without departing from the scope of the present disclosure also lie within the scope of the present disclosure.

As described heretofore, the present disclosure is useful for a polarization separation element dealing with a wide range of angles of incidence by a simple multilayer film (stacked film) without having a need of a structural birefringent layer, a method of designing a polarization separation element, an optical system, and an optical instrument.

The present disclosure shows an effect that it is possible to provide a polarization separation element dealing with a wide range of angles of incidence by a simple multilayer film (stacked film) without having a need of a structural birefringent layer, a method of designing a polarization separation element, an optical system, and an optical instrument.

What is claimed is:

1. A polarization separation element formed between a pair of light transmissive substrates, and having a transmittance of P-polarized light and a transmittance of S-polarized light differing by at least B % or more in an entire section of wavelength from wavelength A1 (nm) to wavelength A2 (nm),
and where,
at a design wavelength λ (nm)
A1=λ×0.86,
A2=λ×1.7, and
B (%)=22.5, wherein
the polarization separation element has a structure of alternately stacked dielectrics in which, a first dielectric having a first refractive index and a second dielectric having a second refractive index lower than the first refractive index are stacked alternately, and
the structure of alternately stacked dielectrics has a broadband polarization separation film configuration having spectral characteristics such that, each of a transmittance height difference of the P-polarized light and a transmittance height difference of the S-polarized light is at most within 15% in a section of wavelength range which is at least ¼ of the entire section of wavelength from the wavelength A1 (nm) to the wavelength A2 (nm), and
the structure of alternately stacked dielectrics, in a first wavelength range narrower than a wavelength range included in the entire section of wavelength, has a first narrowband polarization separation film configuration having spectral characteristics such that, the transmittance of the P-polarized light and the transmittance of the S-polarized light differ by at least 30% or more, in a wavelength section range which is at least ⅛ of the entire section of wavelength from the wavelength A1 (nm) to the wavelength A2 (nm), and the structure of alternately stacked dielectrics, in a second wavelength range not overlapping with the first wavelength range, which is narrower than the wavelength range included in the entire section of wavelength, at least has a second narrowband polarization separation film configuration having spectral characteristics such that, the transmittance of the P-polarized light and the transmittance of the S-polarized light differ by at least 30% or more in a wavelength section range which is at least ⅛ of the entire section of wavelength from the wavelength A1 (nm) to the wavelength A2 (nm).

2. The polarization separation element according to claim 1, wherein
the broadband polarization separation film configuration has both or one of a first broadband polarization separation film configuration and a second broadband polarization separation film configuration, and includes in order from a light transmissive substrate, a first dielectric, a second dielectric, the first dielectric, and the second dielectric, and a film thickness of the first dielectric and a film thickness of the second dielectric satisfy the following expression 1,
the film thickness of the first dielectric (0.24±a1)×d
the film thickness of the second dielectric (0.8±a2)×e
the film thickness of the first dielectric (0.45±a3)×f
the film thickness of the second dielectric (3.3±a4)×g (1)
where,
a coefficient a1=0.15,
a coefficient a2=0.2,
a coefficient a3=0.2,
a coefficient a4=0.6,
a coefficient d is set such that, the first broadband polarization separation film configuration, d=1 and the second broadband polarization separation film configuration, d=1.2 to 1.5,
a coefficient e is set such that, the first broadband polarization separation film configuration, e=1 and the second broadband polarization separation film configuration, e=0.9 to 1.2,
a coefficient f is set such that, the first broadband polarization separation film configuration, f=1 and the second broadband polarization separation film configuration, f=0.4 to 0.8,
a coefficient g is set such that, the first broadband polarization separation film configuration, g=1 and the second broadband polarization separation film configuration, g=0.6 to 0.95, and
in the broadband polarization separation film configuration after the second broadband polarization separation film configuration, a relationship d=e=f=g is not established, and
a calculated value is an optical film thickness (QWOT).

3. The polarization separation element according to claim 1, wherein
each of the first narrowband polarization separation film configuration and the second narrowband polarization separation film configuration, has the first dielectric,
the second dielectric,
the first dielectric,
the second dielectric, and
the first dielectric stacked in order from the light transmissive substrate side, or, has
the second dielectric,
the first dielectric,
the second dielectric,
the first dielectric, and
the second dielectric stacked in order from the light transmissive substrate side, and
a film thickness of the first dielectric and a film thickness of the second dielectric satisfy one of the following expressions (2-1) and (2-2)
the film thickness of the first dielectric (1.975±b1)×h,
the film thickness of the second dielectric (1.975±b2)×i,
the film thickness of the first dielectric (1.825±b3)×j,
the film thickness of the second dielectric (1.675±b4)×k,
the film thickness of the first dielectric (1.675±b5)×l (2-1)
where,
a coefficient b1=0.4,
a coefficient b2=0.4,
a coefficient b3=0.3,
a coefficient b4=0.3, and
a coefficient b5=0.3,
the film thickness of the second dielectric (1.975±b1)×h,
the film thickness of the first dielectric (1.975±b2)×i,
the film thickness of the second dielectric (1.825±b3)×j,
the film thickness of the first dielectric (1.675±b4)×k, and
the film thickness of the second dielectric (1.675±b5)×1 (2-2)
where,
a coefficient b1=0.4,
a coefficient b2=0.4,
a coefficient b3=0.3,
a coefficient b4=0.3, and
a coefficient b5=0.3,
a coefficient h is set such that the first narrowband polarization separation film configuration, h=1 and the second narrowband polarization separation film configuration=0.37±0.05,
a coefficient i is set such that the first narrowband polarization separation film configuration, i=1 and the second narrowband polarization separation film configuration, i=0.46±0.11,
a coefficient j is set such that the first narrowband polarization separation film configuration, j=1 and the second narrowband polarization separation film configuration, j=0.46±0.2,
a coefficient k is set such that the first narrowband polarization separation film configuration, k=1 and the second narrowband polarization separation film configuration, k=0.42±0.16, and
a coefficient l is set such that the first narrowband polarization separation film configuration, l=1 and the second narrowband polarization separation film configuration, l=0.28±0.1,
the calculated value is the optical film thickness (QWOT), and
in the narrowband polarization separation film configuration after the second broadband polarization separation film configuration, a relationship h=i=j=k=l is not established.

4. The polarization separation element according to claim 1, wherein the structure of alternately stacked dielectrics includes a third narrowband polarization separation film configuration differing from the first narrowband polarization separation film configuration and the second narrowband polarization separation film configuration.

5. The polarization separation element according to claim 1, wherein an average refractive index of each four layers from the light transmissive substrate side, in a polarization separation film configuration in contact with the pair of light transmissive substrates disposed at both ends of the structure of alternately stacked dielectrics is within a range of ±0.2 with respect to a refractive index of the light transmissive substrate.

6. The polarization separation element according to claim 1, wherein,
the broadband polarization separation film configuration has spectral characteristics such that, at the maximum value of a range of an angle of incidence used, has a wavelength range for which, a difference in the transmittance of the P-polarized light and the transmittance of the S-polarized light is 10% or more, in a section of wavelength range which is at least ½ of the entire section of wavelength from the wavelength A1 (nm) to the wavelength A2 (nm), and
the broadband polarization separation film configuration, in the range of the angle of incidence used, has spectral characteristics such that, the transmittance height difference of the P-polarized light and the transmittance height difference of the S-polarized light is within 15% in a section of wavelength range which is at least ¼ of the entire section of wavelength from the wavelength A1 (nm) to the wavelength A2 (nm), and
at least one of the narrowband polarization separation film configurations, in the range of the angle of incidence used, satisfies a relationship, the transmittance of the P-polarized light >the transmittance of the S-polarized light, and
as a wavelength range that indicates spectral characteristics such that, the difference in the transmittance of the P-polarized light and the transmittance of the S-polarized light is 30% or more than 30%, has in a section of wavelength range which is at least ⅛ of the entire section of wavelength range from the wavelength A1 (nm) to the wavelength A2 (nm).

7. The polarization separation element according to claim 1, wherein a layer in contact with the light transmissive substrate, a layer between the broadband polarization separation film configuration and one of the narrowband polarization separation film configurations, and at least a layer between the first narrowband polarization separation film configuration and the second narrowband polarization separation film configuration are matched.

8. The polarization separation element according to claim 1, wherein the light transmissive substrate is selected from an alkali-free glass, a borosilicate glass, a fused quartz, a quartz crystal, a crystalline material, a semiconductor substrate, and a synthetic resin.

9. The polarization separation element according to claim 1, wherein a material of the first dielectric and a material of the second dielectric is selected from at least two types or more than two types from TiO, TiO₂, Y₂O₃, Ta₂O₅, ZrO, ZrO₂, Si, SiO₂, HfO₂, Ge, Nb₂O₅, Nb₂O₆, CeO₂, Cef₃, ZnS, ZnO, Fe₂O₃, MgF₂, AlF₃, CaF₂, LiF, Na₃AlF₆, Na₅AL₃F₁₄, A1₂O₃, MgO, LaF, PbF₂, NdF₃, or a mixture thereof.

10. The polarization separation element according to claim 1, wherein for a method of stacking two or more than two dielectrics of a material of the first dielectric and a material of the second dielectric, any one of, vacuum deposition and sputtering, physical film-thickness vapor deposition of ion plating, resistance heating vapor deposition, electron beam heating vapor deposition, high frequency heating vapor deposition, laser beam heating deposition, ionization sputtering, ion beam sputtering, plasma sputtering, ion assist, and radical-assisted sputtering is adopted.

11. The polarization separation element according to claim 1, wherein
the polarization separation element has the structure of alternately stacked dielectrics in which, two or more than two types of dielectrics including a material of the first dielectric and a material of the second dielectric are stacked between a pair of the light transmissive substrates, and
the polarization separation element shows polarization separation characteristics at the maximum angle of incidence of 35 to 60 degrees.

12. The polarization separation element according to claim 1, wherein
the polarization separation element has the structure of alternately stacked dielectrics in which, two or more than two types of dielectrics including a material of the first dielectric and a material of the second dielectric are stacked between a pair of the light transmissive substrates, and
the polarization separation element has an adhesive layer including an adhesive, between a surface of any one of the pair of light transmissive substrates and the structure of alternately stacked dielectrics.

13. A method of designing a polarization separation element separating P-polarized light and S-polarized light in a predetermined wavelength range, formed between a pair of light transmissive substrates, comprising at least the steps of:
designing a broadband polarization separation film configuration having spectral characteristics such that, a transmittance of P-polarized light and a transmittance of S-polarized light in a first wavelength range included in a predetermined wavelength range differ by a predetermined value or a value higher than the predetermined value;
designing a first narrowband polarization separation film configuration having spectral characteristics such that, a transmittance of P-polarized light and a transmittance of S-polarized light in a second wavelength range narrower than the first wavelength range, and included in the first wavelength range, differ by a predetermined value or a value higher than the predetermined value; and
designing a second narrowband polarization separation film configuration having spectral characteristics such that, in a third wavelength range narrower than the first wavelength range and not overlapping with the second wavelength range, and included in the first wavelength range, a transmittance of P-polarized light and a transmittance of S-polarized light differ by a predetermined value or a value higher than the predetermined value.

14. An optical system comprising:
a polarization separation element according to claim 1.

15. An optical instrument comprising:
an optical system according to claim 14.
